(19) United States
(12) Patent Application Publication
(10) Pub. No.: US 2025/0092940 A1
(43) Pub. Date: Mar. 20, 2025

(54) SYSTEM, APPARATUS, AND METHOD FOR CONTROLLING A WORK VEHICLE

(71) Applicant: Vincent Edmund Pawluski, County of Grande Prairie No. 1, AB (CA)

(72) Inventor: Vincent Edmund Pawluski, County of Grande Prairie No. 1, AB (CA)

(21) Appl. No.: 18/963,149

(22) Filed: Nov. 27, 2024

Related U.S. Application Data
(60) Provisional application No. 63/365,489, filed on May 29, 2022.

(30) Foreign Application Priority Data
May 29, 2023 (WO) PCT/CA2023/050734

(51) Int. Cl. F16H 37/12; B60T 7/16

(52) U.S. Cl. CPC F16H 37/12; B60T 7/16

(57) ABSTRACT

A system and method of controlling manually operable control elements of a vehicle using a control apparatus mounted in the vehicle. The control apparatus is mechanically engaged with at least one of the manually operable control elements of the vehicle. A control circuit module receives commands signals from a control source. The control circuit module generates command signals to cause actuation of at least one control actuator to manipulate the control apparatus in response to the command signals, which, in turn, manipulates the manually operable control element of the vehicle.

### CROSS-REFERENCE TO RELATED APPLICATIONS

This application claims the benefit of U.S. Provisional Patent Application No. 63/365,489, filed 29 May 2022, and International Patent Application No. PCT/CA2023/050734, filed 29 May 2023, the contents of which are hereby incorporated herein by reference in their entireties.

### FIELD OF THE DISCLOSURE

The present disclosure relates generally to a system, apparatus, and method for remotely controlling a work vehicle, and in particular to a system, apparatus, and method for operationally engaging a work vehicle for remotely controlling one or more manually controllable output elements thereof.

### BACKGROUND

Many types of work vehicles, for example agricultural tractors, construction vehicles, and the like, comprise one or more output elements such as power take-off (PTO) shafts or hydraulic circuits that may be used to drive one or more features of an implement coupled thereto. These output elements are typically manually controllable and may be operated by an operator via manually operable elements such as control switches within an operator cab of the work vehicle. While in many instances, the operator may prefer to be situated externally of the vehicle to monitor operation of the implement; the operator may have to stay in the cab to operate the vehicle or may have to repeatedly enter the cab to change the operational state of the output elements.

U.S. Pat. No. 6,112,139 to Schubert et al. teaches an apparatus and method for wireless remote control of an output element coupled to a work vehicle. The output element performs work external to the vehicle and is actuated by an actuator controlled by an output controller in response to at least a remote control signal. The apparatus includes a wireless remote transmitter movable with respect to the vehicle and a wireless receiver supported by the vehicle. The transmitter has an actuatable input device for generating a command signal, a transmitter antenna, and a transmitter control circuit which receives the command signal from the input device, generates the remote control signal in response to the command signal, and applies the remote control signal to the transmitter antenna for wireless transmission to the work vehicle. The receiver includes a receiver antenna and a receiver control circuit which receives the remote control signal from the receiver antenna after transmission by the transmitter, and applies the remote control signal to the output controller.

Many work vehicles include forms of output elements, for example hydraulic circuits in many instances, having control circuits that are not actuated through a common electronic circuitry of the vehicle so that the apparatus as described in U.S. Pat. No. 6,112,139 is not compatible with these types of output elements. Furthermore, the wired connection of the apparatus to the electronic circuitry of the work vehicle may require specialized knowledge resulting in time consuming and costly installation.

### SUMMARY

According to one aspect of this disclosure, there is provided a control apparatus for operationally engaging a vehicle having one or more manually operable control elements, each of the one or more manually operable control elements having a mechanical operator-interface, the control apparatus comprising: one or more control actuators each for mechanically engaging the mechanical operator-interface of a corresponding one of the one or more manually operable control elements; a signal receiver for receiving command signals from a remote control; and a control circuit module functionally coupled to the signal receiver and the one or more control actuators for controlling the operation of the one or more control actuators based on the received command signals, to control the operation of the vehicle.

In some embodiments, the signal receiver is a signal transceiver.

In some embodiments, the signal receiver is a wireless signal receiver.

In some embodiments, the control apparatus further comprises: at least one frame for coupling to a supporting structure of the one or more manually operable control elements and for supporting one or more of the one or more control actuators, the signal receiver, and the control circuit module.

In some embodiments, the at least one frame is releasably coupled to an armrest and/or one or more control consoles in an operator cab of the vehicle.

In some embodiments, the control apparatus further comprises: a signaling component for indicating the operation status of the vehicle.

In some embodiments, the signaling component comprises an indicator light for coupling to the vehicle at a position visible from outside of the vehicle.

In some embodiments, the one or more control actuators comprises at least one of: one or more power take-off (PTO) control actuators each for engaging the mechanical operator-interface of a corresponding PTO control element for controlling the operation of a PTO shaft of the vehicle; one or more rotary-speed control actuators each for engaging the mechanical operator-interface of a corresponding rotary-speed control elements for controlling the rotary speed of the PTO shaft; one or more hydraulic control actuators each for engaging the mechanical operator-interface of a corresponding hydraulic control element for controlling the operation of a hydraulic circuit of the vehicle; one or more joystick actuators each for engaging a corresponding joystick or lever of the vehicle; a steering-wheel actuator for engaging a steering wheel of the vehicle; a start-switch actuator for mechanically engaging a handle portion of an operator key inserted in a start switch of the vehicle for actuating the operator key and subsequently the start switch to start or stop an engine of the vehicle; one or more speed control elements each for engaging the mechanical operator-interface of a corresponding speed control element for controlling the speed of the engine of the vehicle; one or more brake control elements for engaging brakes of the work vehicle.

In some embodiments, the engine comprises at least one of an internal combustion engine and a motor.

In some embodiments, at least one of the one or more hydraulic control actuators is configured for engaging the mechanical operator-interface of the corresponding hydraulic control switch for controlling the operation of at least one hydraulic valve of the vehicle.

In some embodiments, the start-switch actuator comprises: a start-switch actuator frame for coupling to a supporting structure of the start switch; a wheel rotatably coupled to the start-switch actuator frame, the wheel comprising a recess for receiving the handle portion of the operator key inserted in the start switch; and an actuator assembly coupled to the wheel for rotating the wheel and subsequently the operator key to start or stop the engine.

In some embodiments, the actuator assembly comprises a single actuator coupled to the wheel via a crank arm.

In some embodiments, the actuator assembly comprises: a movable base; a first actuator coupling the wheel to the base; and a second actuator coupling the base to a fixed point.

In some embodiments, one of the first and second actuators is for rotating the wheel and subsequently the operator key between an OFF position and an ON position of the start switch, and another one of the first and second actuators is for rotating the wheel and subsequently the operator key between the ON position and a START position of the start switch.

In some embodiments, the first actuator is configured for rotating the wheel, and the second actuator is configured for rotating the base.

In some embodiments, the start-switch actuator further comprises a linearly movable gear rack; the wheel is a gear engaging the gear rack; the first actuator couples the gear rack to the base for linearly moving the gear rack with respect to the base; and the second actuator is configured for linearly moving the base.

In some embodiments, the start-switch actuator further comprises one or more delimiters for delimiting the rotation range of the wheel.

In some embodiments, the steering-wheel actuator comprises a driving wheel and one or more driven wheels configured for engaging and sandwiching the steering wheel between the driving wheel and the one or more driven wheels.

In some embodiments, at least one of the one or more control actuators is coupled to a supporting structure; and the supporting structure comprises: a base structure having an interface for coupling to the actuator, the interface comprising a longitudinal bore and a laterally extending recess intersecting the bore, a dial wheel received in the recess, the dial wheel comprising a bore and threads on the inner surface thereof, and a threaded rod extending from the at least one of the one or more control actuators through the bore of the interface and the bore of the dial wheel such that the threads of the threaded rod engage those of the dial wheel.

In some embodiments, the threaded rod is pivotably extending from the at least one of the one or more control actuators.

In some embodiments, the control apparatus further comprises: a first emergency stop button for commanding the one or more control actuators to actuate the one or more manually operable control elements to OFF states to stop the operation of the vehicle.

In some embodiments, the control apparatus further comprises: a power adapter plug insertable into a power socket of the vehicle for powering at least a first subset of the one or more control actuators, the signal receiver, and control circuit module.

In some embodiments, the control apparatus further comprises: a battery module for powering at least a second subset of the one or more control actuators, the signal receiver, and control circuit module.

In some embodiments, the battery module is configured for powering the second subset only when the power adapter plug fails to output power; and the control circuit module is configured for commanding the one or more control actuators to stop the operation of the vehicle when the battery module is powering the second subset.

In some embodiments, the control circuit module is configured for commanding the one or more control actuators to stop the operation of the vehicle after a predefined time duration from receiving a timed shutoff command signal from the remote control.

In some embodiments, the remote control comprises an engine button; a first depress of the engine button is configured for triggering the remote control to send a first signal to the control circuit module for commanding the start-switch actuator to actuate the operator key to an ON position; and a second depress and hold of the engine button is configured for triggering the remote control to send a first signal to the control circuit module for commanding the start-switch actuator to actuate the operator key to a START position until the engine button is released.

In some embodiments, the remote control comprises a second emergency stop button.

In some embodiments, the remote control comprises a key slot for removably receiving a security key for enabling the remote control; and the remote control is disabled when the security key is removed from the key slot.

In some embodiments, the remote control comprises an unlock button for enabling one or more buttons of the remote control.

In some embodiments, the unlock button is configured for enabling the one or more buttons of the remote control for a predefined period of time or until any of the one or more buttons is depressed or while the unlock button is depressed.

### BRIEF DESCRIPTION OF THE DRAWINGS

For a more complete understanding of the disclosure, reference is made to the following description and accompanying drawings, in which:

FIG. 1 is a schematic diagram of a work vehicle, according to some embodiments of this disclosure, the work vehicle comprising one or more add-on control apparatuses for overriding the manual operation of the work vehicle and enabling remote control thereof from a remote-control device;

FIG. 2 is a schematic perspective view of a portion of an armrest panel of the work vehicle shown in FIG. 1;

FIG. 3 is a schematic diagram showing the functional structure of the work vehicle shown in FIG. 1;

FIGS. 4A to 4D show a start-switch frame assembly of the add-on control apparatus of the work vehicle shown in FIG. 1, according to some embodiments of this disclosure, wherein

FIGS. 4A and 4B are perspective views of the start-switch frame assembly from different viewing angles,

FIG. 4C is a front view of the start-switch frame assembly shown in FIG. 4A, and

FIG. 4D is a rear view of the start-switch frame assembly shown in FIG. 4A;

FIG. 5 is a schematic front view of a start switch of the work vehicle shown in FIG. 1;

FIGS. 6A to 6C show a process of starting the engine of the work vehicle shown in FIG. 1 using the start-switch frame assembly shown in FIG. 4A;

FIGS. 7A and 7B are perspective views of a start-switch frame assembly of the add-on control apparatus of the work vehicle shown in FIG. 1 from different viewing angles, according to some embodiments of this disclosure;

FIGS. 8A and 8B are schematic front and rear views of a start-switch frame assembly of the add-on control apparatus of the work vehicle shown in FIG. 1, according to yet some embodiments of this disclosure;

FIGS. 9A and 8B are perspective views of an add-on control apparatus of the work vehicle shown in FIG. 1 from different viewing angles, according to some embodiments of this disclosure;

FIG. 10 is a perspective view of a portion of the add-on control apparatus shown in FIG. 9A;

FIG. 11 is a photo showing an example of a main frame assembly of the add-on control apparatus shown in FIG. 9A;

FIG. 12A is a schematic perspective view of a remote control for remotely controlling the work vehicle shown in FIG. 1;

FIG. 12B is a photo showing an example of a remote control for remotely controlling the work vehicle shown in FIG. 1; and

FIG. 13 shows a circuit connected to a control actuator of the add-on control apparatus shown in FIG. 9A, according to some embodiments of this disclosure.

FIG. 14 illustrates another embodiment of an add-on control apparatus of the work vehicle according to some embodiments of this disclosure for remotely controlling various manually operable control elements in the form of a lever.

FIGS. 15A-15D show an add-on control apparatus of the work vehicle, according to some embodiments of this disclosure for remotely controlling a manually operable control element in the form of a joystick capable of moving in the fore/aft direction and right/left directions, wherein

FIG. 15A is an upper rear perspective view of an embodiment of the add-on joystick control apparatus mounted to an armrest or console of the work vehicle,

FIG. 15B is another perspective view of the add-on joystick control apparatus of FIG. 15A viewed from an upper right side,

FIG. 15C is an exploded perspective view of the add-on joystick control apparatus of FIG. 15A viewed in the same upper right perspective as in FIG. 15A, and

FIG. 15D is an exploded perspective view of the add-on joystick control apparatus of FIG. 15A viewed from a lower right perspective;

FIG. 16 shows another embodiment of an add-on control apparatus of the work vehicle for remotely controlling a manually operable control element in the form of a brake pedal.

FIGS. 17A-17G show another embodiment of an add-on control apparatus of the work vehicle for remotely controlling a manually operable control element in the form of a power take off (PTO) button which requires a button to be depressed and a flange lifted to engage the PTO, wherein

FIG. 17A is perspective view of the add-on PTO control apparatus mounted to an armrest or console of the work vehicle,

FIG. 17B is an exploded perspective view of the add-on PTO control apparatus of FIG. 17A,

FIG. 17C is another exploded perspective view of the add-on PTO control apparatus of FIG. 17A viewed from a different angle,

FIG. 17D is a top plan of the cap of the PTO control apparatus,

FIG. 17E is a cross-section of the cap as viewed along lines E-E of FIG. 17D,

FIG. 17F is a cross-section of the cap as viewed along lines F-F of FIG. 17D, and

FIG. 17G is a partially exploded and partial cut-away perspective view of the add-on PTO control apparatus of FIG. 17A and viewed from the same angle as FIG. 17A.

### DETAILED DESCRIPTION

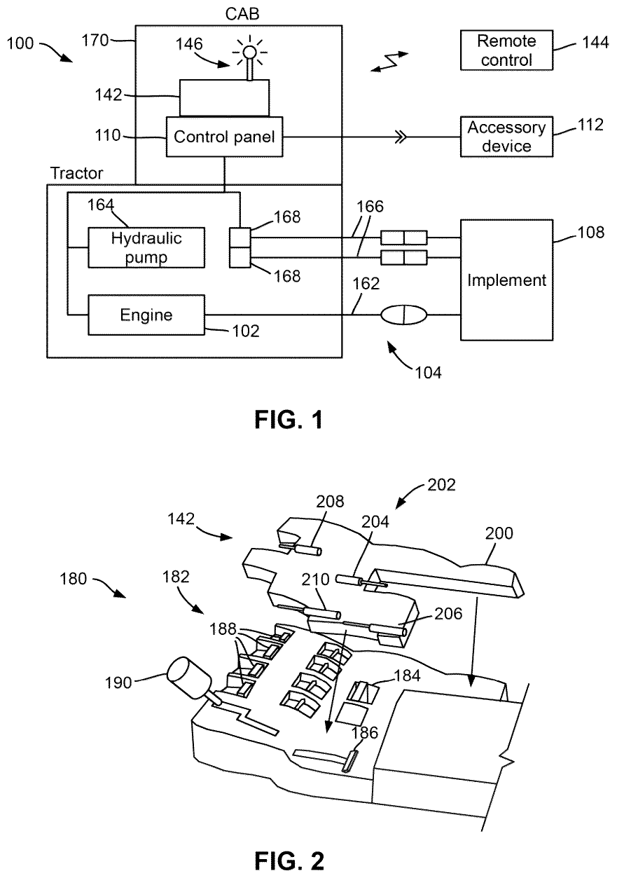

Turning now to FIG. 1, a work vehicle according to some embodiments of this disclosure is shown and is generally identified using reference numeral 100. In these embodiments, the work vehicle may be an agricultural tractor, an agricultural combine harvester, or any other type of self-propelled agricultural vehicle or equipment or machine, or any type of self-propelled construction or industrial vehicle or equipment or machine, or the like. The work vehicle 100 comprises a power source 102 for powering and driving a plurality of output elements 104 (described later) for operating the work vehicle 100 and one or more implements, attachments or machines (collectively hereinafter implements 108) mounted to the work vehicle 100 or pulled or drawn by the work vehicle 100. For example with respect to agricultural work vehicles 100 such as a tractor, the implement 108 may be any type of tillage implement, planting implement, sprayer or applicator implement, or crop or forage harvesting equipment. The implement 108 mounted on the tractor's three point hitch or attached to the tractor's drawbar or elsewhere on the tractor and the implement may be coupled with the tractor's hydraulic ports, or the tractor's drawbar and power take-off (PTO).

As those skilled in the art will appreciate, the power source 102 may be any suitable source for providing power to various parts of the work vehicle 100. For example, the power source 102 in various embodiments may be an internal combustion engine (for example, a diesel engine, a gas engine, or the like), an electrical motor, and/or the like.

The output elements 104 may comprise a PTO shaft 162 having a rotary output drivable by the engine 102 for operating or powering the implements 108. The output elements 104 may also comprise a hydraulic system such as a hydraulic pump 164 drivable or powered by the engine 102 for producing a supply of pressurized hydraulic fluid for actuating one or more implements 108 via one or more hydraulic circuits 166. The hydraulic circuits 166 may comprise one or more hydraulic valves 168 for controlling the flow of the pressurized hydraulic fluid to control the operation of the implements 108.

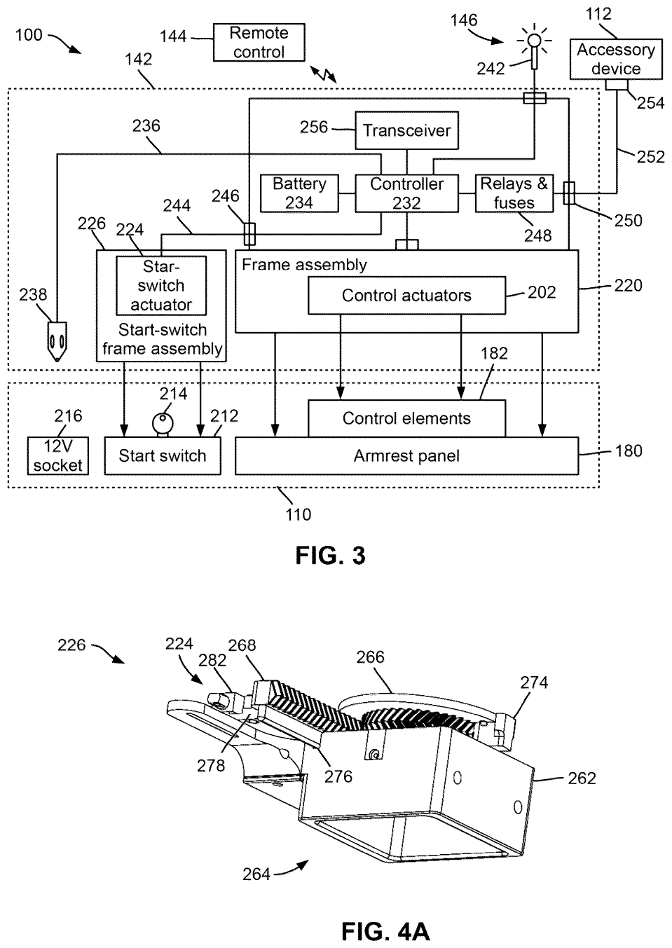

The work vehicle 100 also comprises a control panel assembly 110 usually supported within the operator cab 170 of the work vehicle 100. The control panel assembly 110 comprises one or more manually operable control elements 182 (see FIG. 3) functionally coupled to the power source 102 and the output elements 104 (collectively denoted “operable elements” hereinafter) for controlling the operation of the work vehicle 100, the implements 108, and one or more accessary devices 112. Examples of the accessory devices 112 may be interior and exterior lights, linear actuators, rotary actuators, electric valves, hydraulic valves, solenoid valves, pneumatic valves, and the like.

For example, the control panel assembly 110 usually comprises a manually operable start switch mounted on a start switch panel. The start switch accepts an operator key to allow rotation between an OFF position, an ACCESSORY position, an ON position, and a START position. When an operator turns the operator key to displace the start switch from the OFF position to the ACCESSORY position, the accessory devices of the work vehicle 100 are turned on. When the operator further turns the operator key to the ON position, all electronic circuits of the work vehicle 100 are activated. When the operator biases the start switch from the ON position to the START position, a starter motor of the work vehicle 100 is activated to start the engine 102. After ignition of the engine 102, the operator may release the operator key and the start switch returns to the ON position to maintain the work vehicle 100 in the operable state.

The control panel assembly 110 may also comprise an armrest panel extending alongside the operator seat (not shown) and/or a control console. The armrest panel comprises a plurality of manually operable control elements such as one or more joysticks or levers, one or more control switches, and/or the like. The control switches may be in the form of push buttons which may be depressed or pushed to activate or deactivate, two-way toggle buttons which may be deflected between two opposing positions (such as ON and OFF positions), three-way toggle buttons which may be deflected to opposing positions from a central neutral position (for example, forward and reverse actuating positions), various forms of dials or sliders tunable to various positions for adjusting input values or parameters, and/or the like.

FIG. 2 shows an example of an armrest panel 180 which comprises a plurality of manually operable control elements 182 in various forms such as one or more PTO control elements 184 (for example, in the form of PTO switches), one or more rotary-speed (or rotations per minute (RPM)) control elements 186, one or more hydraulic control elements 188 (for example, in the form of hydraulic control switches), and one or more joysticks or levers 190.

The PTO switch 184 is used for activating and deactivating the PTO shaft 162. In this example, the PTO switch 184 is a toggle switch displaceable between an ON position and an OFF position to activate and deactivate the PTO shaft 162 respectively. However, those skilled in the art will appreciate that, in some instances, the PTO switch 184 may be a single button for toggling the PTO shaft 162 ON and OFF (that is, turning the PTO shaft 162 ON if the PTO shaft 162 is currently OFF or turning the PTO shaft 162 OFF if it is currently ON). In other instances, the PTO switch 184 may comprise separate ON and OFF buttons for activating and deactivating the PTO shaft 162 respectively when depressed by the operator, or the PTO may be actuated by moving a lever between an ON position and an Off position.

The RPM control element 186 is used for controlling the RPM of the engine 102 and thus the RPMs of the PTO shaft 162. The RPM control element 186 in this instance may comprise a dial or slider tunable to generate appropriate control signals for the engine controller of the work vehicle 100 to change the operating RPM value. In other instances, the RPM control element 186 may comprise one or more buttons depressible by the operator to change the operating RPM value from the idling level to a predefined and/or programmable level associated with that button. In still other embodiments, the RMP control element 186 may be a lever.

The hydraulic control switches 188 are used for controlling the hydraulic valves 168. In some instances, a hydraulic valve 168 may be associated with and functionally coupled to a single hydraulic switch 188 in the form of a two-way toggle switch displaceable from a neutral position in opposing directions towards opposing forward and reverse positions for controlling the hydraulic fluid in the respective hydraulic circuit 166 to be idle/neutral, or flow in either one of opposing forward and reverse directions. Alternatively, a hydraulic valve 168 may be associated with and functionally coupled to a pair of hydraulic control buttons 188 such that depressing one of the buttons 188 may actuate flow in the respective hydraulic circuit 166 in a forward direction, and depressing the other button may actuate flow in the respective hydraulic circuit 166 in a reverse direction. In still other embodiments, the hydraulic control switches 188 may be levers that are movable to open and close the associated hydraulic valves 168.

The joysticks or levers 190 are typically used for controlling the movement of the work vehicle 100 and/or for powering or actuating the implements 108 mounted or attached thereto.

As shown in FIG. 2, each manually operable control element 182 generally comprises a mechanical operator-interface such as a switch handle, a slider handle, a dial body, a joystick or lever, and/or the like, to be held by an operator for manually operating the control element 182.

Referring again to FIG. 1, in these embodiments, one or more add-on control apparatuses 142 are coupled to the control panel assembly 110 such as the armrest panel 180 and/or a control console. Each add-on control apparatus 142 comprises one or more control actuators mechanically engaging the mechanical operator-interface of a corresponding control element 182 to “override” the manual operation thereof and enable remote control thereof from a remote-control device 144. In these embodiments, at least one add-on control apparatus 142 may also comprise a signaling component such as one or more indicator lights 146 visible from outside of the work vehicle 100 for indicating the operation status of the work vehicle 100.

For example, FIG. 2 shows an add-on control apparatus 142 coupled to the armrest panel 180. The add-on control apparatus 142 comprises an armrest frame 200 supporting a plurality of control actuators 202 (such as linear actuators, rotary actuators, and/or the like) thereon to override the manual operation of the control elements 182 of the armrest panel 180 and enable remote control thereof (described in more detail later). For example, the control actuators 202 of the add-on control apparatus 142 may comprise one or more PTO control actuators 204 for engaging and actuating the one or more PTO switches 184, one or more RPM control actuators 206 for engaging and actuating the one or more RPM control elements 186, one or more hydraulic control actuators 208 for engaging and actuating the hydraulic control switches 188, and one or more joystick actuators 210 for actuating the joysticks or levers 190.

FIG. 3 is a schematic diagram showing the functional structure of the work vehicle 100. As described above, the control panel assembly 110 comprises the armrest panel 180 having various control elements 182 and a start switch 212 (which is also considered a control element herein after) for receiving the teeth portion of an operator key 214 to allow an operator to hold and turn the handle portion of the operator key 214 to start the engine 102. The control panel assembly 110 also comprises one or more electrical sockets 216 such as one or more 12V sockets.

In these embodiments, the add-on control apparatus 142 comprises a main frame assembly 220 and a start-switch frame assembly 226. The start-switch frame assembly 226 comprises a rigid body in the form of a rigid frame or rigid enclosure for coupling to the start switch 212 and receiving thereon or therein the start-switch actuator 224 functionally coupled to the main frame assembly 220 for actuating the start switch 212 under the commands from the main frame assembly 220.

Similarly, the main frame assembly 220 comprises a rigid body in the form of a rigid frame or rigid enclosure for receiving thereon or therein the control actuators 202, a controller or control circuit module 232, a battery module 234, a relay-and-fuse module 248 having one or more relays and fuses, a transceiver 256, indicator lights 146, and other components as needed (not shown). The body may be, for example, a single molded body of continuous, seamless, integrally molded plastic material and comprise the interface shaped and sized to mate in close relationship to the contours of at least a portion of the control panel assembly 110 for coupling thereto. The main frame assembly 220 may be demountably coupled to the control panel assembly 110 using suitable means such as straps with releasable fasteners, screws, nails, and/or the like for securing the main frame assembly 220 to the control panel assembly 110 in fixed relationship thereto.

The control circuit module 232 generally comprises a circuit board, a central processor, and a memory (not shown). Programming instructions are stored in the memory and may be executed by the processor for executing the various functions described herein for operating the add-on control apparatus 142.

The battery module 234 comprises one or more batteries for outputting electrical power at a predefined voltage such as 12 volts (V). The battery module 234 cooperates with a diode so that it can be charged by the electrical system of the work vehicle 100 but the diode does not allow electrical power to feed back to the electrical system of the work vehicle 100.

The battery module 234 is coupled to one or more of the control circuit module 232, transceiver 256, the control actuators 202, and other electrical components for providing electrical power thereto. The control circuit module 232 may also be connected to an external 12 V adapter plug 238 via a flexible lead or wire 236 such that the control circuit module 232 may be powered by the external electrical power supply of the work vehicle 100 when the adapter plug 238 is inserted into the power socket 216 of the control panel assembly 110. Similarly, other electrical components may also be connected to the power socket 216. For example, the transceiver 256 may be connected to the power socket 216 for powering and the battery module 234 may also be connected to the power socket 216 for charging. Thus, the battery module 234 may be used as a backup electrical power for the control circuit module 232 in the event when the adapter plug 238 is removed from the socket 216 or when the socket 216 of the work vehicle 100 fails.

For example, in the event of a loss of external power to the control circuit module 232 from the work vehicle 100, the battery module 234 provides sufficient power to enable all of the various control elements 182 and 212 of the work vehicle 100 to be actuated in an appropriate manner to cease operation of the corresponding operable elements 102 and 104. Furthermore, the control circuit module 232 may be programmed to automatically respond to detection of a loss of power from the adapter plug 238 connected to the work vehicle 100 and automatically actuate all control actuators 202 and 224 to their home safe positions to deactivate the operable elements 102 and 104. This includes ceasing operation of the PTO shaft 162 and/or returning one or more hydraulic circuits 166 to respective neutral positions.

The indicator lights 146 is preferably installed or otherwise positioned at a position highly visible from the exterior of the operator cab 170 in substantially all directions about the perimeter of the work vehicle 100. In some embodiments, the indicator lights 146 comprises a mast 242 in the form of a rigid pole. In some embodiments, the mast 242 may be a telescopic pole or may be foldable.

The transceiver 256 is configured for wirelessly communicating with the remote control 144 for receiving user instructions therefrom and/or for reporting statuses of various elements of the work vehicle 100 thereto. In embodiments wherein the control circuit module 232 does not have the functionality of reporting statuses to the remote control 144, the transceiver 256 may be a signal receiver only capable of receiving command signals from the remote control 144. Preferably, the transceiver or signal receiver 256 is a wireless transceiver or wireless signal receiver. However, those skilled in the art will appreciate that, in some alternative embodiments, the transceiver or signal receiver 256 may be a wired transceiver or wired signal receiver.

As shown in FIG. 3, the control circuit module 232 connects to the accessory devices 112 via a relay and fuse module 248 and a pin connector 250. More particularly, a flexible lead 252 with a sufficient length is connected to the pin connector 250 and extends therefrom to a location external of the operator cab 170 to connect to a pin connector 254 of the accessory devices 112, thereby connecting the accessory devices 112 to the control circuit module 232.

As described above, the add-on control apparatus 142 also comprises a plurality of control actuators 202 of the main frame assembly 220 (which include the control actuators 204 to 210 engage the control elements 182 of the armrest panel 180) and a start-switch actuator 224 of the start-switch frame assembly 226 (which engages the start switch 212 and the handle portion of the operator key 214). The control circuit module 232 connects to the control actuators 202 and also connects to the start-switch actuator 224 via a flexible lead 244 with a releasable pin connection 246 connected in series therewith.

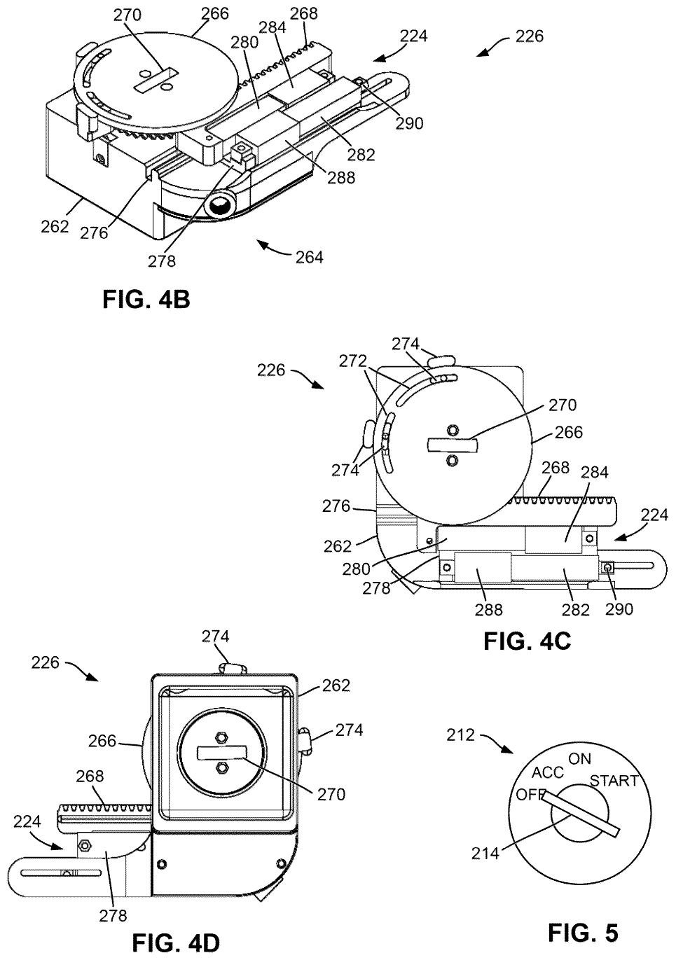

FIGS. 4A to 4D show the start-switch frame assembly 226 according to some embodiments of this disclosure. As shown, the start-switch frame assembly 226 comprises a frame 262 supporting thereon the start-switch actuator 224. The frame 262 comprises an interface 264 for engaging a supporting structure of the start switch 212.

The start-switch actuator 224 comprises a gear 266, a gear rack 268, a linearly movable base 278, and a pair of actuator components 280 and 282.

The gear 266 comprises a recess or slot 270 at the center thereof for receiving therein the handle portion of the operator key 214 (not shown), and one or more delimiting slots 272 about the edge thereof for receiving therein one or more delimiters 274 such that the rotation of the gear 266 is limited to a predefined range by the one or more delimiters 274.

The gear rack 268 is linearly moveably along a track 276 of the frame 262. The gear rack 268 engages the gear 266 to convert the linear movement of the gear rack 268 to rotatory movement of the gear 266.

The first actuator component 280 couples the gear rack 268 to the base 278. Specifically, the first actuator component 280 comprises a body 284 with the rear side thereof coupled to the base 278. The front portion of the body 284 comprises a longitudinal bore (not shown) movably receiving therein a rod 286 and a motor (not shown) electrically connected to the control circuit module 232 and engaging the rod 286. The rod 286 forwardly extends out of the longitudinal bore of the body 284 and is coupled to the gear rack 268.

The second actuator component 282 couples the base 278 to a fixed point such as an anchor point on the frame 262 of the start-switch frame assembly 226. Specifically, the second actuator component 282 comprises a body 288 with the front side thereof coupled to the base 278. The rear portion of the body 288 comprises a longitudinal bore (not shown) movably receiving therein a rod 290 and a motor (not shown) electrically connected to the control circuit module 232 and engaging the rod 290. The rod 290 rearwardly extends out of the longitudinal bore of the body 288 and is coupled to the anchor point on the frame 262 of the start-switch frame assembly 226.

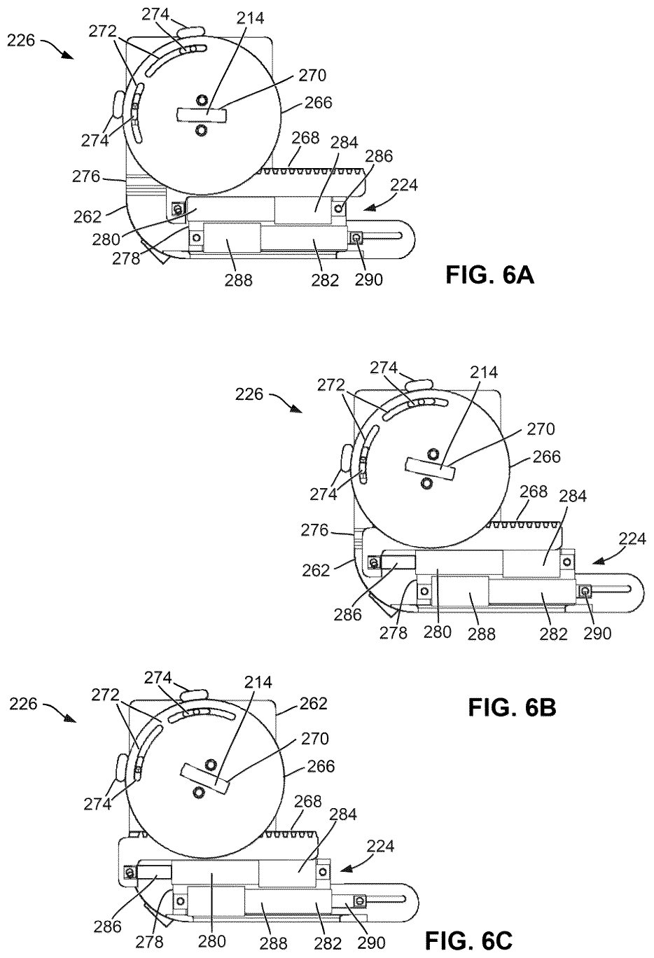

With reference to FIG. 5 which shows an example of the start switch 212, FIGS. 6A to 6C illustrate the operation of the start-switch actuator 224.

FIG. 6A shows the start-switch actuator 224 and the handle portion of the operator key 214 received in the slot 270 of the gear 266 of the start-switch actuator 224. The start-switch actuator 224 is at an inactivated state and the key 224 is at the OFF position (see FIG. 5).

As shown in FIG. 6B, when the operator uses the remote control 144 to command the control circuit module 232 to start the work vehicle 100, the control circuit module 232 activates the motor of the first actuator component 280 to actuate the rod 286 to further extend out of the bore of the body 284 of the first actuator component 280. As the rod 286 is coupled to the gear rack 268, the gear rack 268 is moved forwardly and causes the gear 266 to rotate clockwise thereby rotating the key 214 from the OFF position to the ON position.

As shown in FIG. 6C, after the key 214 is rotated to the ON position, the control circuit module 232 activates the motor of the second actuator component 282 to actuate the rod 290 to further extend out of the bore of the body 288 of the second actuator component 282. As the body 288 of the second actuator component 282 is coupled to the base 278 and the rod 290 is coupled to the frame 262 of the start-switch frame assembly 226, the start-switch actuator 224 (except the rod 290) and consequently the gear rack 268 are moved forward to further rotate the gear 266 and actuate the operator key 214 to the START position and maintain the operator key 214 at the START position for several seconds to start the engine 102, or alternatively maintain the operator key 214 at the START position as long as the START button on the remote control 144 (described in more detail later) is depressed. Then, the motor of the second actuator 282 retracts the rod 290 into the bore of the body 288 of the second actuator 282, which causes rearward movement of start-switch actuator 224 and the gear rack 268 and counterclockwise rotation of the gear 266 (see FIG. 6B), thereby rotating the operator key 214 to the ON position.

When the operator uses the remote control 144 to command the control circuit module 232 to turn off the work vehicle 100, the control circuit module 232 activates the motor of the first actuator 280 to retract the rod 286 into the bore of the body 284 of the first actuator 280. The gear rack 268 is then moved rearwardly and causes the gear 266 to rotate counterclockwise, thereby rotating the key 214 to the OFF position (see FIG. 6A).

In some embodiments, the second actuator 282 may be first activated to actuate the operator key 214 from the OFF position to the ON position and the first actuator 280 may be then activated to actuate the operator key 214 from the ON position to the START position to start the engine 102.

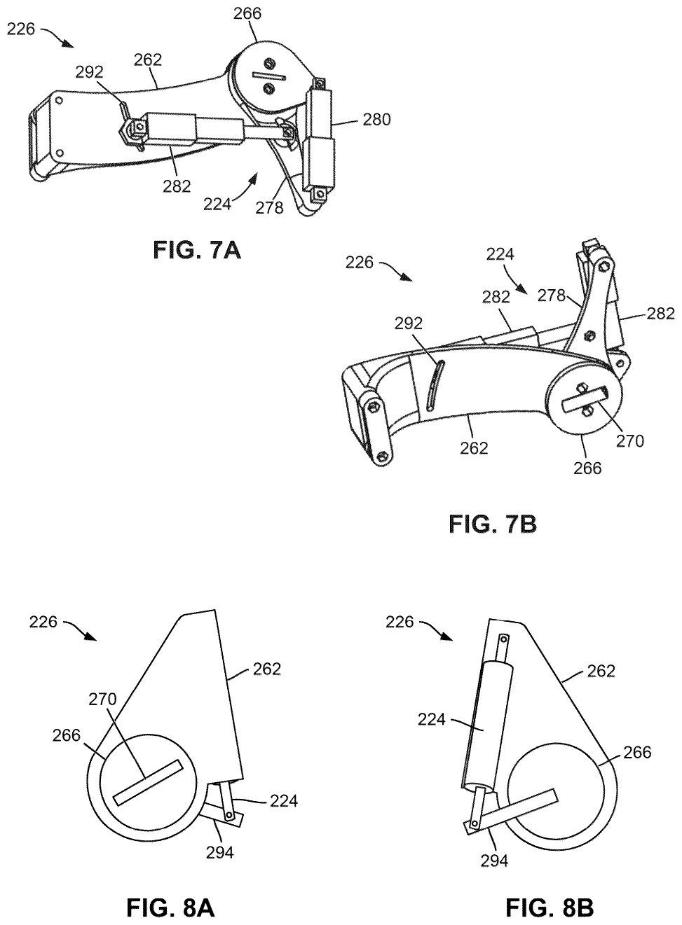

FIGS. 7A and 7B show the start-switch frame assembly 226 according to some alternative embodiments of this disclosure. The start-switch frame assembly 226 is similar to that shown in FIGS. 4A to 4D except that the start-switch frame assembly 226 in these embodiments does not comprise any gear rack and the gear 266 is replaced with a wheel (also identified using reference numeral 266) rotatably coupled to the base 278. Moreover, the second actuator 282 is coupled to the frame 262 of the start-switch frame assembly 226 and is movable in a slot 292 thereon.

To start the engine 102, the first actuator 280 is configured for rotating the wheel 266 to actuate the operator key 214 (not shown) from the OFF position to the ON position and the second actuator 282 is configured for further rotating the base 278 (and thus the wheel 266 thereon) to actuate the operator key 214 from the ON position to the START position.

Although not shown, the start-switch frame assembly 226 in these embodiments may also comprise one or more delimiters for delimiting the rotation range of the wheel 266.

In some alternative embodiments, the second actuator 280 may be configured for actuating the operator key 214 (not shown) from the OFF position to the ON position and the first actuator 282 may be configured for further actuating the operator key 214 from the ON position to the START position.

FIGS. 8A and 8B show the start-switch frame assembly 226 according to some embodiments of this disclosure. As shown, the start-switch frame assembly 226 comprises a frame 262 rotatably receiving a wheel 266 thereon. The wheel 266 comprises a recess or slot 270 for receiving therein the handle portion of the operator key 214 (not shown). An actuator 224 is coupled to the frame 262 at one end and coupled to the wheel 266 at the other, opposite end via a crank arm 294 for rotating the wheel 266 and the operator key 214 between various operating positions.

Although not shown, the start-switch frame assembly 226 in these embodiments may also comprise one or more delimiters for delimiting the rotation range of the wheel 266.

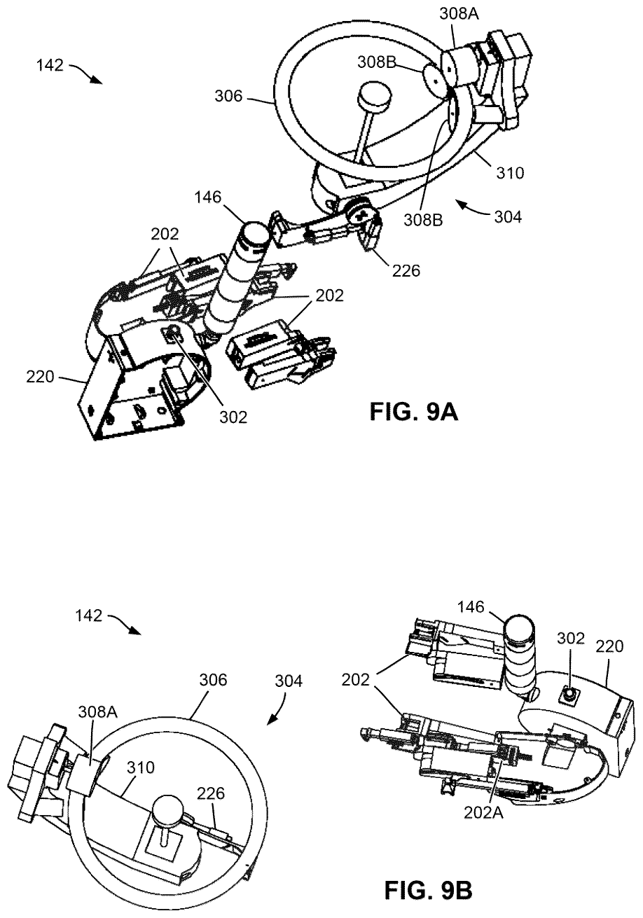

FIGS. 9A and 9B show an add-on control apparatus 142 according to some embodiments of this disclosure. As shown, the add-on control apparatus 142 comprises a frame assembly 220 receiving therein the circuits 232, 234, 248, and 256, the indicator light 146, a plurality of control actuators 202 (including the start-switch frame assembly 226) functionally connected to the control circuit module 232 for actuating the control elements 182 under the command of the control circuit module 232, and an in-cab emergency stop button 302 on the frame assembly 220 for commanding the control actuators 202 and 224 to actuate all control elements 182 to the OFF state to stop the operation of the work vehicle 100 and the implements 108 thereof.

In these embodiments, one of the control actuators 202 is a control assembly 304 for controlling the steering wheel 306 of the work vehicle 100. The control assembly 304 comprises a driving wheel 308A actuatable by a motor (not shown) under the commands of the control circuit module 232, and a plurality of driven wheels 308B rotatably coupled to a frame 310. The wheels 308A and 308B pressurize and sandwich the steering wheel 306 therebetween (for example, the driving wheel 308A above the steering wheel 306 and two driven wheels 308B therebelow) and act as the actuators 202 for actuating and rotating the steering wheel 306 for changing the moving direction of the work vehicle 100.

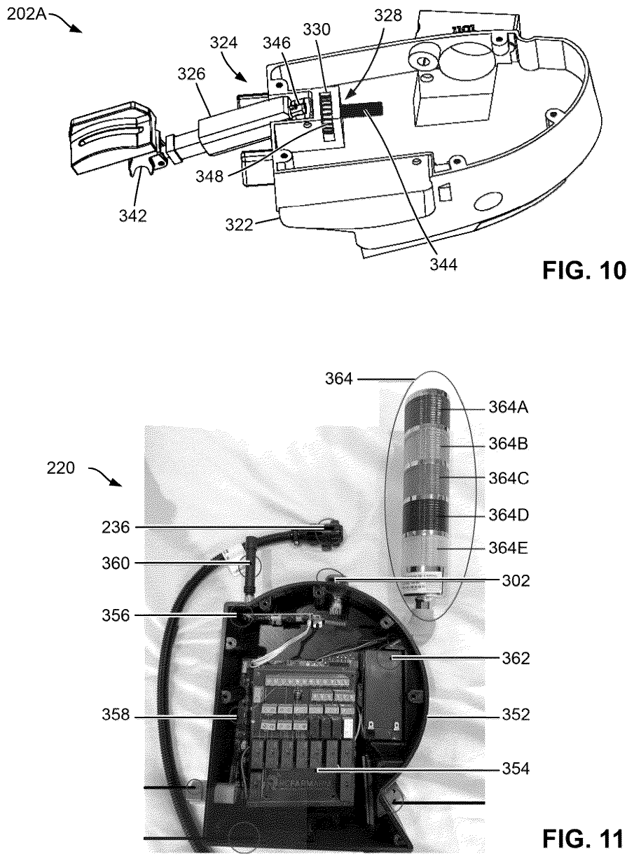

Other control actuators 202 may take any suitable forms as described above. In these embodiments, one or more of the control actuators 202 such as the control assembly 202A may have a structure for the operator to adjust the position thereof. The detail of the control assembly 202A is shown in FIG. 10.

As shown in FIG. 10, the control assembly 202A comprises a base 322 having an interface 324 for coupling to the actuator 326. The interface 324 comprises a longitudinal bore 328 and a laterally extending recess 330 intersecting the bore 328.

The actuator 326 comprises a control-element adapter 342 at the front end thereof for coupling to the control element (not shown). The rear end of the actuator 326 is coupled to a threaded rod 344 via a pivot 346. A dial wheel 348 having a bore and threads on the inner surface thereof is received in the recess 330. The threaded rod 344 extends through the bore 328 and the bore of the dial wheel 348 such that the threads of the threaded rod 344 engage those of the dial wheel 348. Thus, the longitudinal position of the actuator 326 may be adjusted by the operator by rotating the dial wheel 348.

FIG. 11 shows an example of the main frame assembly 220 of the add-on control apparatus 142. As shown, the main frame assembly 220 comprises an enclosure 352 receiving therein a main circuit board 354 implementing the control circuit module 232, a remote receiver system circuit board 356 and a wireless remote relay circuit board 358 implementing the transceiver 256 and connected to a radio communications receiver antenna 360 for communication with the remote control 144. A safety backup battery 362 is used for powering the circuit boards 354, 356 and 358. The main frame assembly 220 also comprises a power supply cord 236 for using an external power (for example, via the 12 V socket 216 (not shown), to power the circuit boards 354, 356 and 358.

The main frame assembly 220 comprises a system status light system 146 extending out of the enclosure 352 for indicating the status of the work vehicle 100. The system status light system 146 comprises a plurality of lights such as a first light 364A indicating that the remote system is engaged and ignition key is ON, a second light 364B indicating that the PTO is engaged, a third light 364C indicating that the engine RPM is engaged, a fourth light 364D indicating that the first hydraulic circuit is engaged, and a fifth light 364E indicating that the second hydraulic circuit is engage.

The main frame assembly 220 also comprises the in-cab emergency stop button 302 for commanding the one or more control actuators 202 and 224 to actuate the one or more manually operable control elements to the OFF states to stop the operation of the work vehicle 100 and the implements 108 thereof. The main frame assembly 220 further comprises an ignition key module connection port (such as a six-pin connection port) for connecting the start-switch frame assembly 226 (for example, the motors of the start-switch actuator 224 thereof), and a user accessory port (such as a four-pin connection port) for connecting the accessory device 112.

In some embodiments, the one or more add-on control apparatuses 142 may further comprise one or more RPM control actuators 206 mechanically engaging the mechanical operator-interface of one or more RPM control elements 186 of the power source 102 such as the throttle of the engine (which may be an internal combustion engine or a motor, as described above) to “override” the manual operation thereof and enable remote control thereof from the remote-control device 144. As those skilled in the art will appreciate, the RPM control elements 186 for controlling the RPMs of the engine 102 may be in various forms such as a paddle, a lever, a dial, a slider, or a plurality of push buttons. Accordingly, the RPM control actuators 206 may comprise a linear actuator, a rotary actuator, a plurality of push button actuators similar to those described above for engaging the mechanical operator-interface of corresponding RPM control elements 186.

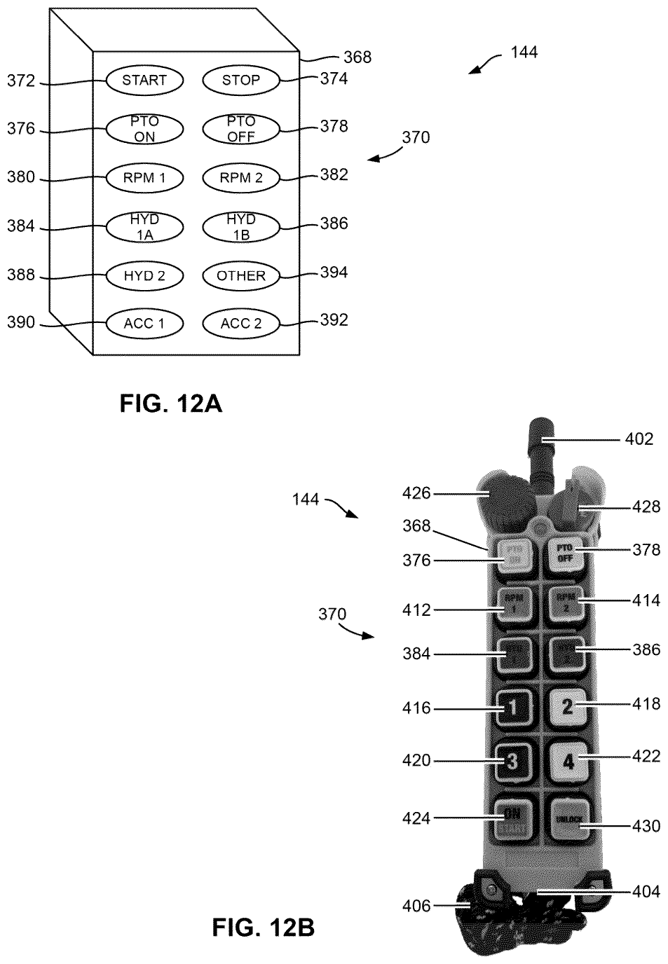

FIG. 12A shows an example of the remote control 144. As shown, the remote control 144 comprises a housing 368 supporting a plurality of buttons 370. When a button 364 is depressed by an operator, a circuit board (not shown) of the remote control 144 transmits a corresponding command wirelessly to the transceiver 256 of the add-on control apparatus 142. In receipt of the start command signal, the control circuit module 232 then commands a respective control actuator 202 to actuate the associated control element 182 to operate the work vehicle 100 or the implement 108 thereof.

In this example, the remote control 144 comprises a START button 372, a STOP button 374, a PTO ON button 376, a PTO OFF button 378, one or more RPM buttons 380 and 382, one or more hydraulic buttons 384, 386, and 388, and one or more accessory buttons 390 and 392. The remote control 144 may also comprise other buttons 394 as needed.

The START button 372 and a STOP button 374 are used for commanding the start-switch actuator 224 to actuate the start switch 212 to start and turn off the engine 102, respectively. When the START button 372 is pressed, a start command signal is generated by the remote control 144 and transmitted to the transceiver 256 of the add-on control apparatus 142. Upon receiving the start command signal from the transceiver 256, the control circuit module 232 commands the start-switch actuator 224 to actuate the start switch 212 from the OFF position to the START position and hold the start switch 212 in the START position for a predefined start duration, for example a few seconds, followed by returning the start switch 212 to the ON position upon expiry of the predefined duration, thereby starting the engine 102 of the work vehicle 100.

When the STOP button 374 is pressed, a stop command signal is generated by the remote control 144 and transmitted to the transceiver 256 of the add-on control apparatus 142. Upon receiving the stop command signal from the transceiver 256, the control circuit module 232 command the start-switch actuator 224 to actuate the start switch 212 from the ON position to the OFF position to stop the engine 102 of the work vehicle 100.

In some embodiments, the remote control 144 may comprise a single START/STOP button for starting and stopping the engine 102 of the work vehicle 100. Pressing the START/STOP button when the start switch 212 is at the OFF position causes the start-switch actuator 224 to actuate the start switch 212 from the OFF position to the START position and hold the start switch 212 in the START position for a predefined start duration followed by returning the start switch 212 to the ON position upon expiry of the predefined duration, thereby starting the engine 102 of the work vehicle 100. On the other hand, pressing the START/STOP button when the start switch 212 is at the ON position causes the start-switch actuator 224 to actuate the start switch 212 from the ON position to the OFF position to stop the engine 102 of the work vehicle 100.

In some embodiments, the control circuit module 232 may be further configured to receive a timed shutoff command signal from the remote control 144. In this instance, the control circuit module 232 displaces the start switch 212 into the OFF position using the start-switch actuator 224 upon expiry of a predefined shutdown duration following receipt of the timed shutoff command signal from the remote control 144. In this instance, the work vehicle 100 is allowed to run for a period of time, for example two to five minutes, to cool down following a period of use, while the operator has left.

The remote control 144 may also comprise a timed shutoff button (not shown) to generate the timed shutoff command signal as described above.

The PTO ON button 376 and the PTO OFF button 378 are used for commanding the PTO control actuator 204 to actuate the PTO switch 184 to the ON and OFF positions to turn the PTO shaft 162 ON and OFF, respectively.

In some embodiments, the remote control 144 may comprise a single PTO button for turning the PTO shaft 162 ON and OFF. Pressing the PTO button when the PTO switch 184 is at the OFF position causes the PTO control actuator 204 to actuate the PTO switch 184 from the OFF position to the ON position to turn the PTO shaft 162 ON. On the other hand, pressing the PTO button when the PTO switch 184 is at the ON position causes the PTO control actuator 204 to actuate the PTO switch 184 from the ON position to the OFF position to turn the PTO shaft 162 OFF.

In some embodiments where the work vehicle 100 comprises separate PTO ON and PTO OFF switches, the PTO ON button 376 may be associated with the PTO ON switch for turning the PTO shaft 162 ON and the PTO OFF button 378 may be associated with the PTO OFF switch for turning the PTO shaft 162 OFF. In some embodiments wherein the remote control 144 comprises a single PTO button, the PTO button is associated with both PTO ON and PTO OFF switches for alternately actuating the PTO ON and PTO OFF switches.

The one or more RPM buttons 380 and 382 are used for commanding one or more RPM control actuators 206 to actuate the RPM control element 186 to set the RPM to specific values. In some embodiments, instead of having the RPM buttons 380 and 382, the remote control 144 may comprise a dial or slider for setting the RPM to specific values.

The one or more hydraulic buttons 384, 386, and 388 are used for commanding one or more hydraulic control actuators 208 to actuate one or more hydraulic control switches 188 towards opposing forward and reverse positions for controlling the hydraulic fluid in the respective hydraulic circuit 166 to be idle/neutral, or flow in either one of opposing forward and reverse directions, or to actuate one or more hydraulic control switches 188 to turn one or more hydraulic valves 168 of hydraulic circuits 166 on and off.

In some embodiments, two hydraulic buttons may be associated with one hydraulic circuit 166 for displacing a corresponding hydraulic valve 168 between different positions corresponding to forward and reverse actuation. In these embodiments, one hydraulic button may be associated with a corresponding hydraulic control actuator to activate a forward hydraulic control switch and the other hydraulic button may be associated with another hydraulic control actuator to activate a reverse hydraulic control switch.

Alternatively, two hydraulic buttons may cooperate with a single hydraulic control actuator that operates a single toggle type hydraulic control switch on the work vehicle 100 to displace the toggle in opposing directions using the same actuator depending upon which of the two hydraulic buttons is depressed.

In some other embodiments, a single hydraulic button may be associated with the hydraulic circuit 166 for generating a single hydraulic command signal to be received by the control circuit module 232. The control circuit module 232 alternates between actuating one or more hydraulic control actuators 208 to displace one or more hydraulic control switches 188 to set the corresponding hydraulic circuit 166 into a forward state and actuating the one or more hydraulic control actuators 208 to displace the one or more hydraulic control switches 188 to set the corresponding hydraulic circuit 166 into a reverse state.

In some embodiments, each of the hydraulic buttons 384, 386, and 388 may be a momentary button which continues to actuate the hydraulic circuit 166 in the corresponding forward or reverse state only for as long as the button is pressed, and may actuate the hydraulic circuit 166 to the neutral state when the button is no longer pressed. Both the hydraulic control switches 188 on the work vehicle 100 and the actuation of the hydraulic control actuators 208 by the control circuit module 232 may be programmed as momentary actuating buttons in these embodiments.

Alternatively, the hydraulic control switches 188 on the work vehicle 100 may be programmed to function as latching switches such that a momentary actuation of the hydraulic control switch 188 causes latching of the hydraulic valve 168 to remain in the forward state or reverse state until the corresponding hydraulic control actuator 208 reaches the end of travel, or until the hydraulic valve 168 has been latched in the corresponding forward or reverse state for a predefined duration dictated by the programming of the work vehicle 100. In these embodiments, a momentary actuation of the hydraulic buttons 384, 386, and 388 on the remote control 144 results in the control circuit module 232 commanding the hydraulic control actuators 208 to actuate momentarily, but the resulting actuation of the hydraulic valve 168 is latched for a predefined duration.

In some embodiments, the hydraulic control switches 188 on the work vehicle 100 may be momentary buttons which only actuate the corresponding hydraulic circuit 166 in a forward or reverse orientation as long as the hydraulic control switch 188 remains depressed. In these embodiments, the control circuit module 232 may be programmed to latch actuation of the corresponding hydraulic switch actuator 208 for a predefined duration in response to a momentary hydraulic command signal from the remote control 144 resulting from a momentary actuation of the corresponding hydraulic button 384, 386, or 388.

The remote control 144 also includes one or more accessory buttons 390 and 392 for generating accessory command signals received by the control circuit module 232 to control the accessory device 112. Similar to the description above, a pair of accessory buttons 390 and 392 may be associated with the accessory device 112 with one accessory button 390 for turning the accessory device 112 on and the other accessory button 392 for turning the accessory device 112 off. Alternatively, a single accessory button may be associated with the accessory device 112 for turning the accessory device 112 on and off.

The remote control 144 may further comprise one or more other buttons 394 for remotely operating other elements or implements of the work vehicle 100.

FIG. 12B shows another example of the remote control 144. As shown, the remote control 144 comprises a housing 368 having a plurality of buttons 370, an antenna 402, and a battery compartment 404. A safety lanyard 406 is attached to the housing 368.

Similar to the remote control described above, when a button 364 is depressed by an operator, a circuit board (not shown) of the remote control 144 transmits a corresponding command wirelessly via the antenna 402 to the transceiver 256 of the add-on control apparatus 142. In receipt of the start command signal, the control circuit module 232 then command a respective control actuator 202 to actuate the associated control element 182 to operate the work vehicle 100 or the implement 108 thereof.

In this example, the plurality of buttons 370 of the remote control 144 include a PTO ON button 376, a PTO OFF button 378 (similar to those shown in FIG. 12A), a pair of engine RPM buttons 412 and 414 for controlling the rotary speed of the engine 102, a pair of hydraulic buttons 384, 386 (similar to those shown in FIG. 12A), and four accessary buttons 416 to 422 for controlling the accessory device 112.

The remote control 144 also comprises an engine button 424. When the start switch 212 of the work vehicle 100 is at the OFF position and the engine button 424 is depressed, the remote control 144 transmits a signal to the control circuit module 232 to command the start-switch actuator 224 to actuate the start switch 212 to the ON position. Then, the operator may depress the engine button 424 and maintain the engine button 424 at the depressed state for a period of time. The remote control 144 then transmits another signal to the control circuit module 232 to command the start-switch actuator 224 to actuate the start switch 212 to the START position and maintain the start switch 212 at the START position until the operator releases the engine button 424. A next depress of the engine button 424 triggers the remote control 144 to transmit a third signal to the control circuit module 232 to command the start-switch actuator 224 to actuate the start switch 212 to the OFF position to stop the operation of the work vehicle 100.

For safety considerations, the remote control 144 in these embodiments comprises a remote emergency stop button 426, a remote security key 428, and an unlock button 430. Similar to the in-cab emergency stop button 302, the remote emergency stop button 426 is used for commanding the one or more control actuators 202 and 224 to actuate the one or more manually operable control elements to the OFF states to stop the operation of the work vehicle 100 and the implements 108 thereof.

The remote security key 428 comprises a security key 428 removably inserted into a key slot (not shown) for enabling the functions of the remote control 144. When the security key 428 is removed from the key slot, the remote control 144 is disable.

The unlock button 430 is for “unlocking” or enabling one or more “special” buttons of the remote control 144 and preventing accidental operations thereof. More specifically, after the unlock button 430 is depressed, the one or more special buttons are enabled for a predefined period of time or until any of the one or more special buttons is depressed. Therefore, every time when the operator needs to operate a special button, the operator has to depress the unlock button 430 first and then depress the desired special button within the predefined period of time.

For example, the unlock button 430 in some embodiments is a PTO/engine starter safety unlock button 430 for unlocking the engine button 424 and the PTO ON button 376 and preventing accidental start of the engine 102 and PTO shaft 162. For example, the operator needs to first depress the PTO/engine starter safety unlock button 428 and then depress the engine button 424 as described above to start the engine 102. The operator also needs to first depress the PTO/engine starter safety unlock button 428 and then depress the PTO ON button 376 to turn on the PTO shaft 162.

In some embodiments, the one or more special buttons are enabled when the unlock button 430 is depressed and are disabled when the unlock button 430 is released. Therefore, the operator needs to depress and hold the unlock button 430 and then depress a desired special button while the unlock button 430 is depressed to use the desired special button to trigger corresponding operation of the work vehicle 100.

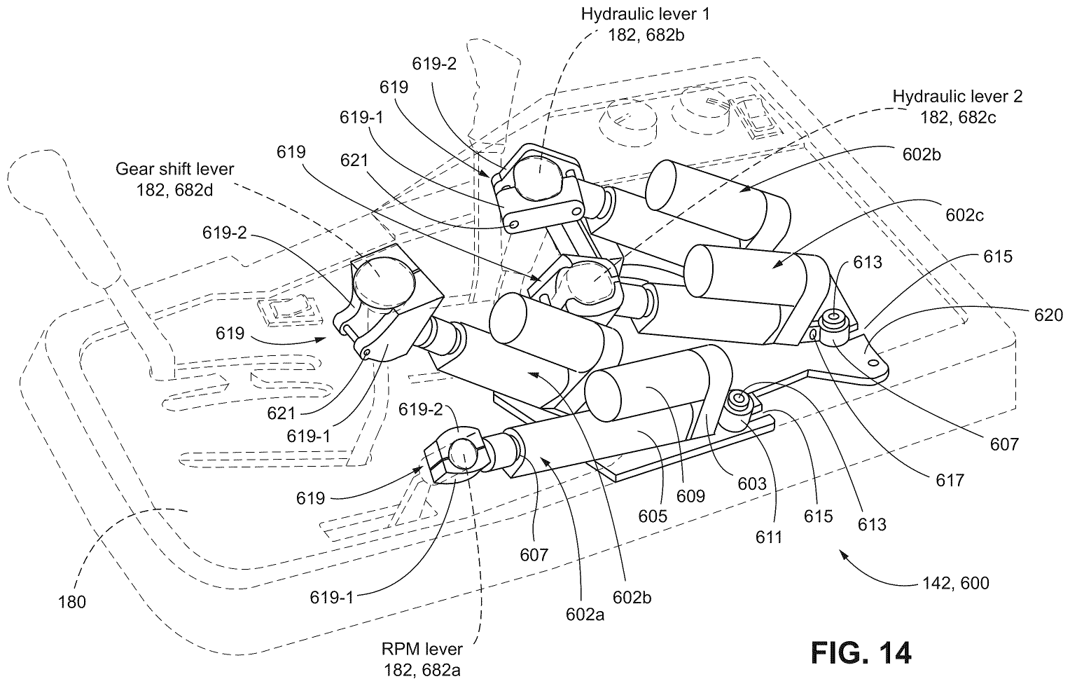

FIG. 14 shows another add-on control apparatus 142, designated generally by reference number 600, for remote control of various manually operable control elements 182 in the form of lever control elements 682 on an armrest panel or console 180 of a work vehicle 100. In this embodiment of the add-on control apparatus 600 includes a main frame 620 that mounts or secures to the armrest panel or console 180 of the work vehicle 100, such as by threaded fasteners, rivets, clamps, brackets, or the like. The main frame 620 pivotally supports one or more control actuators 602 (which correspond to the control actuators 202 as identified above and otherwise referenced throughout this description) that engage with one of the levers 682. In this illustrative example, one of the control element levers 682 is an RPM or throttle lever 682a. Another is a first hydraulic lever 682b. Another is a second hydraulic lever 682c. Another is a gearshift/joystick lever 682d. Each of the levers 682a, 682b, 682c, 682d includes a corresponding actuator 602a, 602b, 602c, 602d. In this embodiment, each of the actuators 602a, 602b, 602c, 602d is an electric linear actuator which includes a base end 603, a barrel 605 and a rod 607 that is extendable from the barrel 605. An electric motor 609 drives gears within the barrel to cause the rod 607 to extend from the barrel 605 and to retract within the barrel 605 as is well known in the art. The base end 603 is secured to the main frame 620 by an actuator mount 611 that allows the actuator 602 to rotate about a generally vertical pin 613. The actuator mount 611 may also be movable fore and aft along a slot 615 in the main frame 620 in order to selectively position the distal end of the rod 607 near the lever 682a, 682b, 682c, 682d when the rod 207 is fully retracted. The base end 603 of each of the actuators 602a, 602b, 602c, 602d may also be pivotable with respect to the actuator mount 611 about a generally horizontal pin 617. A lever attachment 619 is secured to the distal end of the rod 607 of each of the actuators 602a, 602b, 602c, 602d. The lever attachment 619 may include first and second halves 619-1, 619-2. Each half 619-1, 619-2 may be configured with contours or recesses to receive the knob end or grip end of each of the levers 682a, 682b, 682c, 682d. The halves 619-1, 619-2 may be secured together by threaded connectors 621, such that when secured together, the lever attachment 619 is securely yet removably attached to the lever 682a, 682b, 682c, 682d.

In this embodiment, the electric motors 609 of the actuators 602a, 602b, 602c, 602d are functionally connected to the control circuit module 232 and are actuated under the command of the control circuit module 232 as previously described above in connection with the embodiments of the add-on control apparatus 142 of FIGS. 2, 4-8B and 9A-11.

It should be appreciated that when each of the linear actuators 602a, 602b, 602c, 602d is actuated to extend or retract the rod 607, the respective lever 682a, 682b, 682c, 682d will be forced forwardly or rearwardly, respectively. For example if the rod 607 of the linear actuator 602a secured to the throttle lever 682a is extended, the engine speed or engine RPMs will increase. Likewise, if the rod 607 of the linear actuator 602a secured to the throttle lever 682a is retracted, the engine speed or engine RPMs will decrease. Similarly, if the rod end 607 of the first or second linear actuators 602b, 602c secured to the respective hydraulic levers 682b, 682c is extended or retracted, the hydraulic valves controlling the flow of hydraulic fluid to and from the hydraulic actuators on the work vehicle 10 and/or implement 180 will be opened or closed. The extensions and retraction of the rod 607 of the linear actuator 602d secured to the gearshift/joystick lever 682d may perform different functions depending on the type of transmission of the work vehicle 100. For example, if the work vehicle 100 is equipped with a powershift transmission (and assuming the transmission is placed in a forward gear or reverse gear position, as opposed to neutral or park, or is within a forward or reverse shift range), the extension and retraction of the rod 607 will move the gearshift/joystick lever 609d forward and rearward, respectively, resulting in the work vehicle's transmission to up-shift gears or down-shift gears, respectively. If the work vehicle 100 is equipped with a hydrostatics transmission (HST) or continuously variable transmission (CVT), the extension and retraction of the rod 607 will move the gearshift/joystick lever 609d forward and rearward, respectively, causing the ground speed of the work vehicle 100 to increase or decrease, respectively.

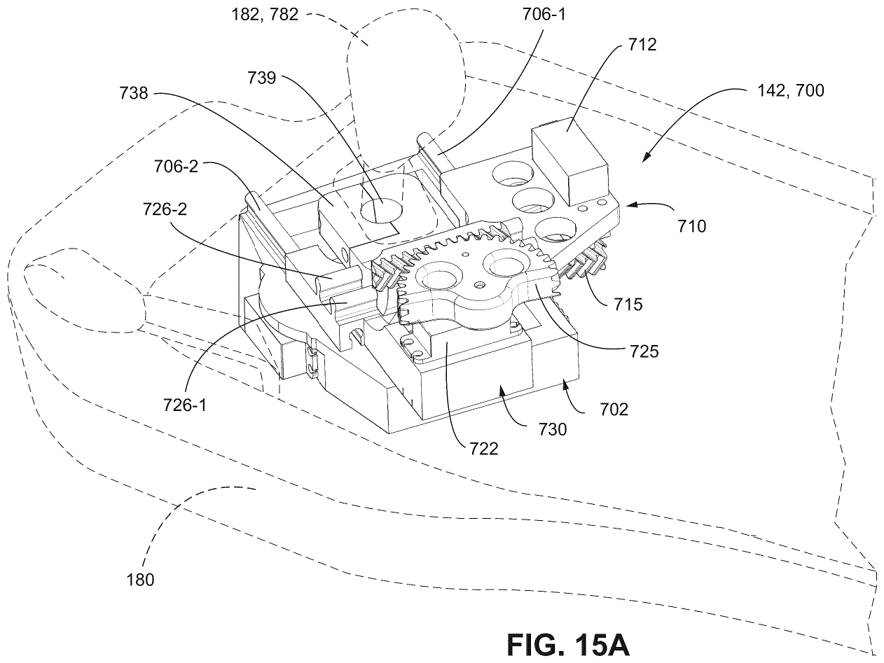

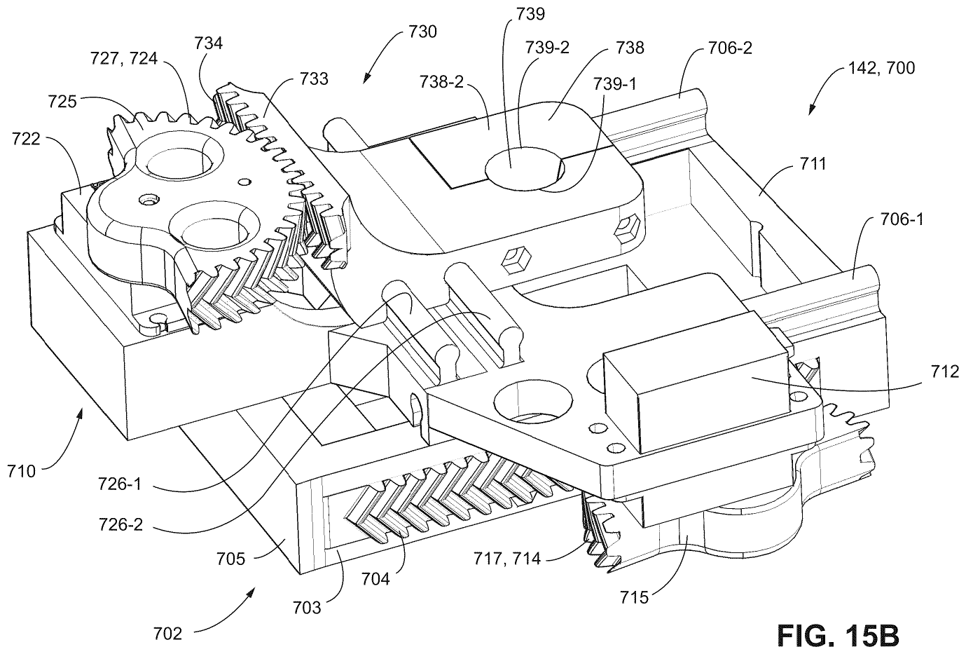

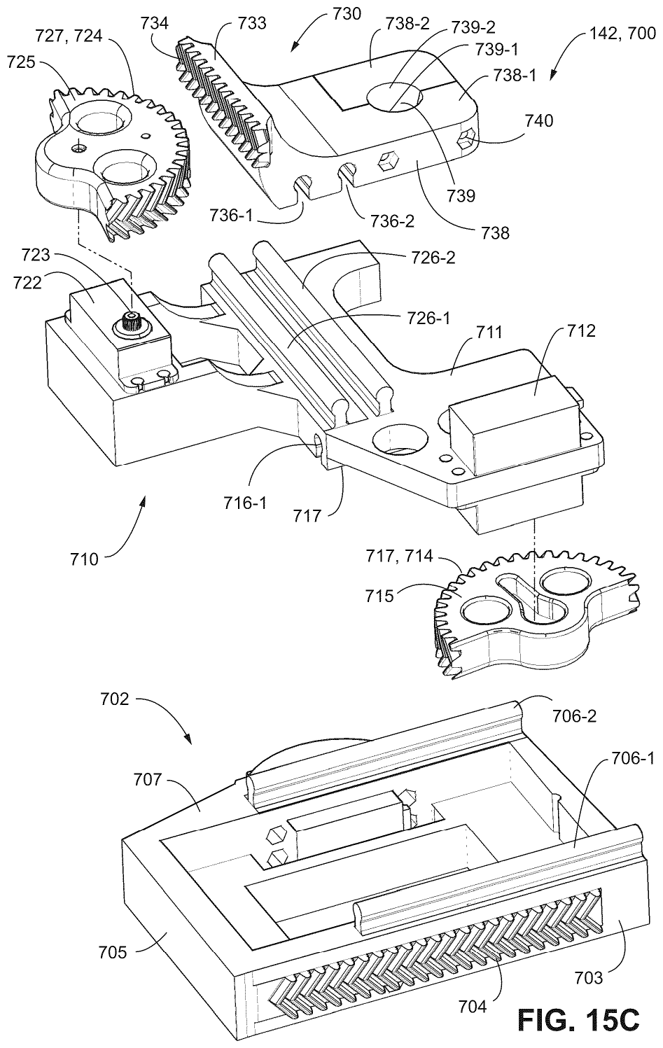

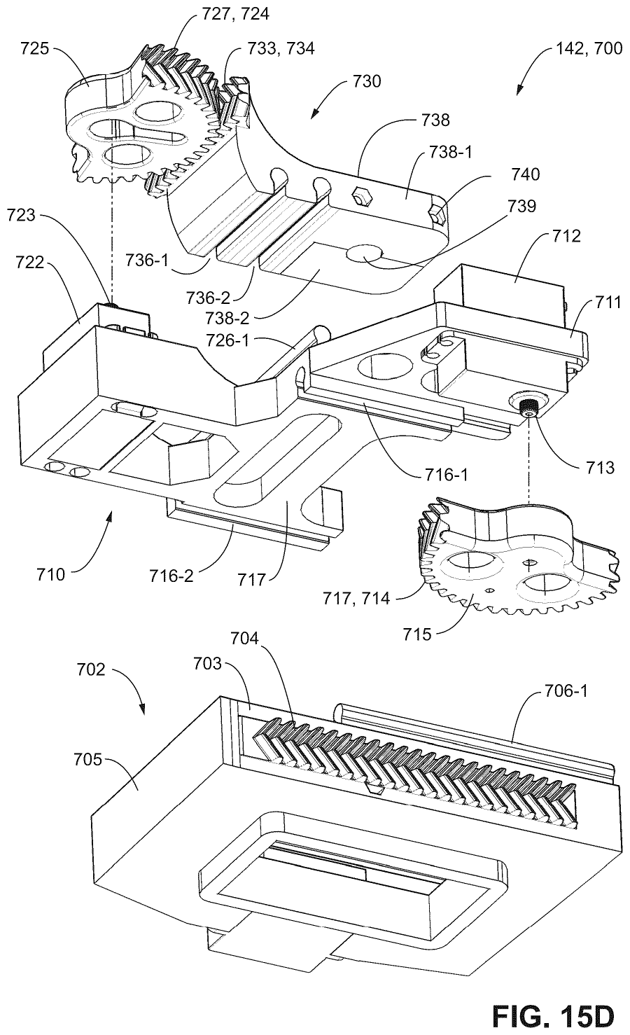

FIGS. 15A-15D shows another add-on control apparatus 142, designated generally by reference number 700, for remote control of a manually operable control element 182 in the form of a joystick control element 782 capable of moving in both the fore/aft directions and left/right directions. For example, the joystick control element 782 may be moved in the forward (fore) direction to increase ground speed of the work vehicle 100 and may be moved in the rearward (aft) direction to decrease ground speed of the work vehicle; and the joystick control element 782 may be moved to the right to upshift the work vehicle in steps from a low speed range to a medium speed range, and then from medium to a high speed range; and the joystick control element 782 may be moved to the left to downshift the work vehicle in steps from a high speed range to a medium speed range, and then from medium to a lower speed range. FIG. 15A is an upper rear perspective view of the add-on joystick control apparatus 700 mounted or secured to the armrest panel or console 108 of the work vehicle 100. FIG. 15B is an other perspective view of the add-on joystick control apparatus 700 viewed from an upper right side. FIG. 15C is an exploded perspective view of the add-on joystick control apparatus 700 viewed in the same upper right perspective as in FIG. 15A. FIG. 15D is another exploded perspective view of the add-on joystick control apparatus 700 viewed from the lower right perspective.

As best viewed in the exploded views of FIGS. 15C and 15D, to move the joystick control element 782 in both the fore/aft directions and left/right directions, the add-on joystick control apparatus 700 includes a main frame 702 which supports a fore/aft subassembly 710 which is capable of moving in the forward (fore) direction and the rearward (aft) direction relative to the main frame 702 and a right/left subassembly 730 capable of moving laterally to the right and laterally to the left with respect to the fore/aft subassembly 710. The main frame 702 may be generally rectangular with longitudinal side walls 703 extending the fore/aft direction and a lateral side walls 705 extending in the right/left direction. The main frame 702 is configured to securely mount to the armrest or console 108 of the work vehicle 100 by threaded fasteners, rivets or any other suitable mounting means. One of the longitudinal sidewalls 703 of the main frame 702 includes gear teeth 704. A top wall 707 of the main frame 702 includes fore/aft guide rails 706-1, 706-2 that extend in the longitudinal (fore/aft) direction and are laterally spaced. The fore/aft subframe 710 includes a for/aft base 711. A portion of the fore/aft base 711 is oriented transverse to the main frame 702 and supports a fore/aft drive motor 712 which drives a fore/aft gear shaft 713 (FIG. 15D). A fore/aft gear 715 secures to the fore/aft gear shaft 713. The fore/aft gear 715 includes an arcuate surface 717 with gear teeth 714 that engage with the gear teeth 704 on the longitudinal sidewall 703 of the main frame 702. An underside 717 of the fore/aft base 711 includes fore/aft rail receivers 716-1, 716-2 that extend in the longitudinal (for/aft) direction and are laterally spaced and configured to mateably and slidably receive the fore/aft guide rails 706-1, 706-2 on the top wall 705 of the main frame 702. The fore/aft base 711 supports a right/left drive motor 722 which drives a right/left gear shaft 723. A right left gear 725 secures to the right/left gear shaft 723. The right/left gear 725 includes an arcuate surface 727 with gear teeth 724. A topside 719 of the fore/aft base plate 711 includes right/left guide rails 726-1, 726-2 that extend in the lateral (right/left) directions transverse to the fore/aft guide rails 706-1, 706-2 and are longitudinally spaced. The right/left subframe 730 includes a right/left base 731. A portion of the right/left base 731 is oriented transverse to the fore/aft subframe 710 and includes an end wall 733 with gear teeth 734. When assembled, the gear teeth 724 of the right/left gear 725 engage with the gear teeth 734 of the end wall 733. An underside 737 of the right/left base 731 includes right/left rail receivers 736-1, 736-2 that extend in the lateral (right/left) direction and are longitudinally spaced and configured to mateably and slidably receive the right/left guide rails 726-1, 726-2 on the topside 719 of the fore/aft base 711. A portion of the right/left base 731 includes a joystick attachment 738 with an aperture 739 configured to matingly receive a portion of the joystick 782 (FIG. 15A) therein. In the embodiment shown, the joystick attachment 738 includes a first joystick attachment portion 738-1 with a first aperture portion 739-1 and a second joystick attachment portion 738-2 with a second aperture portion 739-2. The second joystick attachment portion 738-2 may be removable from the first joystick attachment portion 738-1 so that a portion of the joystick control element 782 can be positioned within the first aperture portion 739-1. The second joystick attachment portion 738-2 can then be secured to the first joystick attachment portion 738-1 with threaded fasteners 740 or other suitable attachment means and with the first and second aperture portions 739-1, 739-2 aligned and with the joystick control element 782 received within the formed aperture 739.

In this embodiment, the fore/aft electric drive motor 712 and the right/left electric drive motor 722 (which correspond to the control actuators 202 as identified above and otherwise referenced throughout this description) are functionally connected to the control circuit module 232 and are actuated under the command of the control circuit module 232 as previously described above in connection with the embodiments of the add-on control apparatus 142 of FIGS. 2, 4-8B, 9A-11 and 14.

In operation, upon command from the remote controller 144, the fore/aft electric drive motor 712 will drive the fore/aft gear 715 clockwise or counterclockwise. The gear teeth 714 of the fore/aft gear 715 will engage with the gear teeth 704 on the longitudinal sidewall 703 of the main frame 702 causing the fore/aft subassembly 710 to move along the fore/aft guide rails 706-1, 706-2 on the top wall 705 of the main frame 702, thereby moving the joystick control element 782 received within the joystick attachment 738 either forward (fore) or rearward (aft), respectively, and thus increasing or decreasing, respectively, the ground speed of the work vehicle. Likewise, upon command from the remote controller 144, the right/left electric drive motor 722 will drive the right/left gear 725 clockwise or counterclockwise. The gear teeth 724 of the right/left gear 725 will engage with the gear teeth gear teeth 734 of the end wall 733 of the right/left subframe 730 causing the right/left subassembly 730 to move along the right/left guide rails 726-1, 726-2 on the topside 719 of the fore/aft base 711, thereby moving the joystick control element 782 received within the joystick attachment 738 either laterally to the right or laterally to the left, respectively, and thus upshift or downshifting, respectively, the work vehicle.

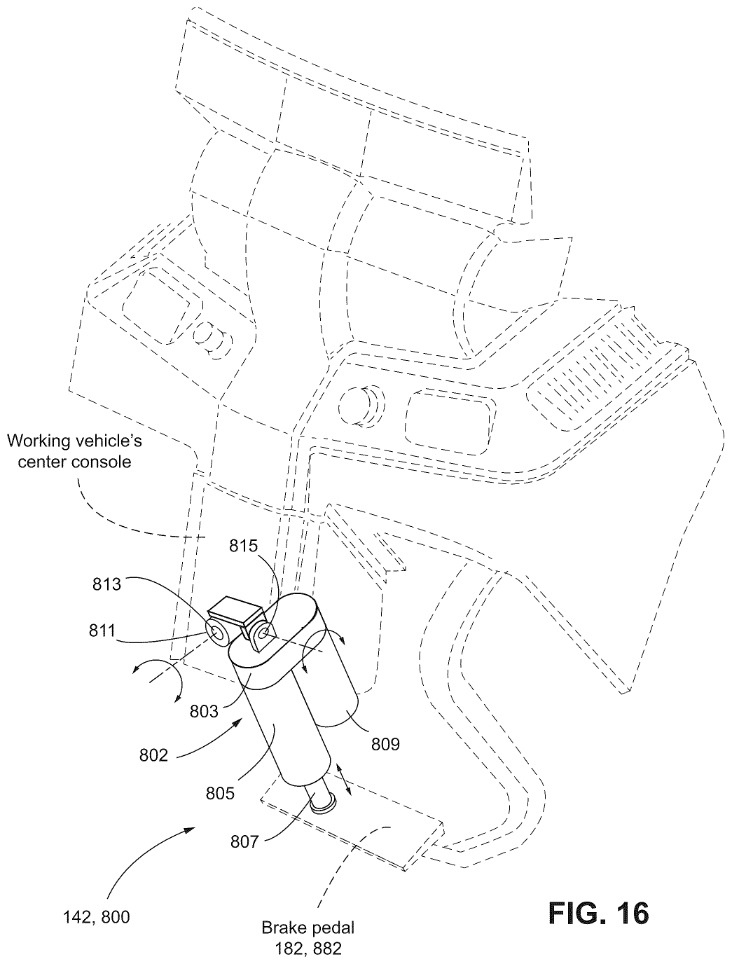

FIG. 16 shows another add-on control apparatus 142, designated generally by reference number 800, for remote control of a manual operable control element 182 in the form of a brake pedal control element 882 of the work vehicle 100. A control actuator 802 (which corresponds to the control actuators 202 as identified above and otherwise referenced throughout this description), such as a linear actuator, includes a base end 803, a barrel 805 and a rod 807 that is extendable from the barrel 805. An electric motor 809 drives gears within the barrel to cause the rod 807 to extend from the barrel 805 and to retract within the barrel 805 as is well known in the art. The base end 803 may be secured by an actuator mount 811 to the center console or a plate (not shown) secured to the center console or elsewhere in the operator cab of the work vehicle 100. The actuator mount 811 may allow the control actuator 802 to pivot about a longitudinal pin or axis 813 and the control actuator 802 may be movable fore and aft along the longitudinal pin or axis 813, to ensure that the rod 807 of the linear actuator aligns longitudinally with respect to the brake pedal control element 882. The actuator mount 811 may be pivotable about a lateral pin or axis 815 and the actuator mount 811 may be laterally adjustable, to ensure that rod end 807 of the actuator 802 aligns laterally with the brake pedal control element 882. It should be appreciated that when the linear actuator 802 is actuated to extend, the brake pedal control element 882 will be depressed causing the ground speed of the work vehicle 100 to slow and eventually stop as the rod 807 is further extended toward the floor of the operator cab. It should also be appreciated that if the work vehicle 100 is equipped with right and left brake pedals, one of the right or left brake pedals will include a locking plate that can be pivoted in place to lock the right and left brake pedals together such that upon depressing one of the brake pedals both of the brake pedals will be depressed. Accordingly, if the locking plate is in place, only one actuator 802 will be required to depress both of the right and left brake pedals at the same time. Alternatively, if the locking plate is not used, two linear actuators 802 could be provided (one for each of the right and left brake pedals). The remote control 144 and actuators 202 may be configured to actuate (extend and retract) simultaneously by the press of a single button on the remote control 144 or the remote control may have a separate button for each of the 202 for independent actuation.

In this embodiment, the electric drive motor 809 of the control actuator 802 is functionally connected to the control circuit module 232 and is actuated under the command of the control circuit module 232 as previously described above in connection with the embodiments of the add-on control apparatus 142 of FIGS. 2, 4-8B, 9A-11, 14 and 15.

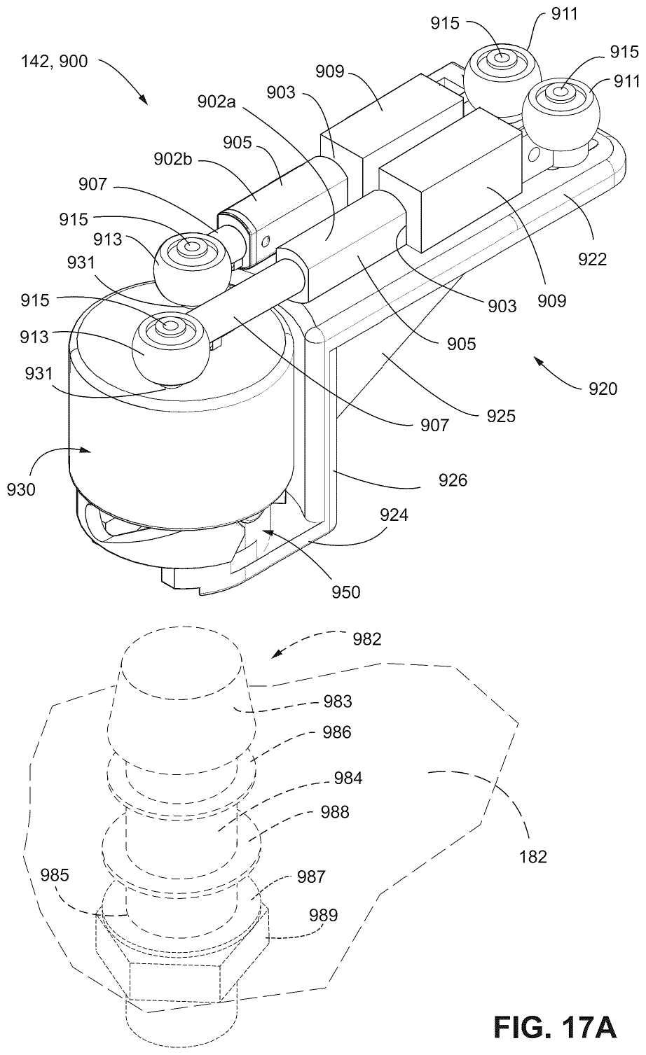

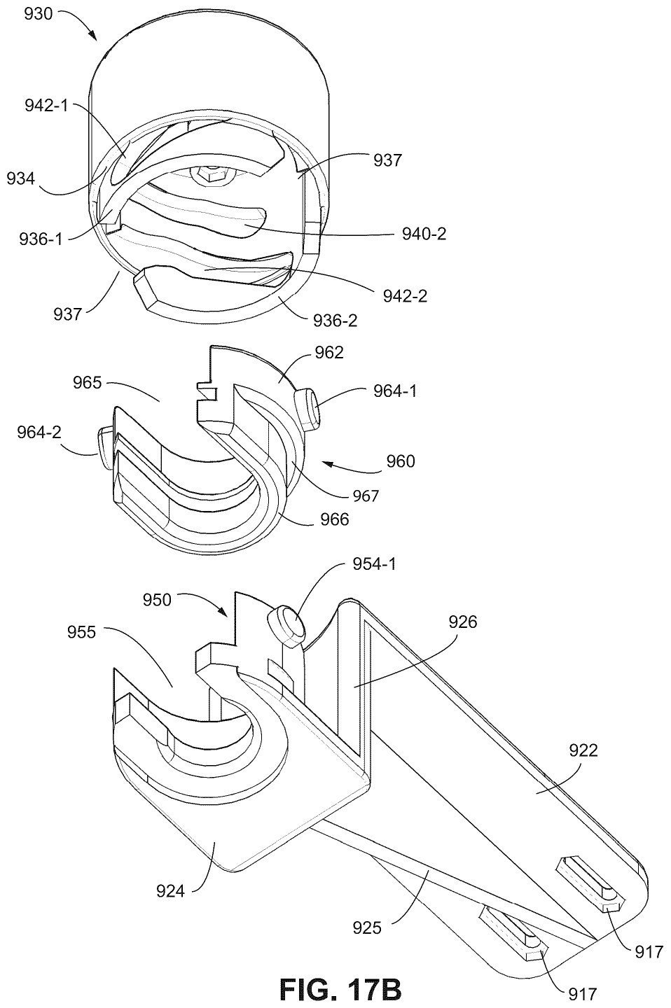

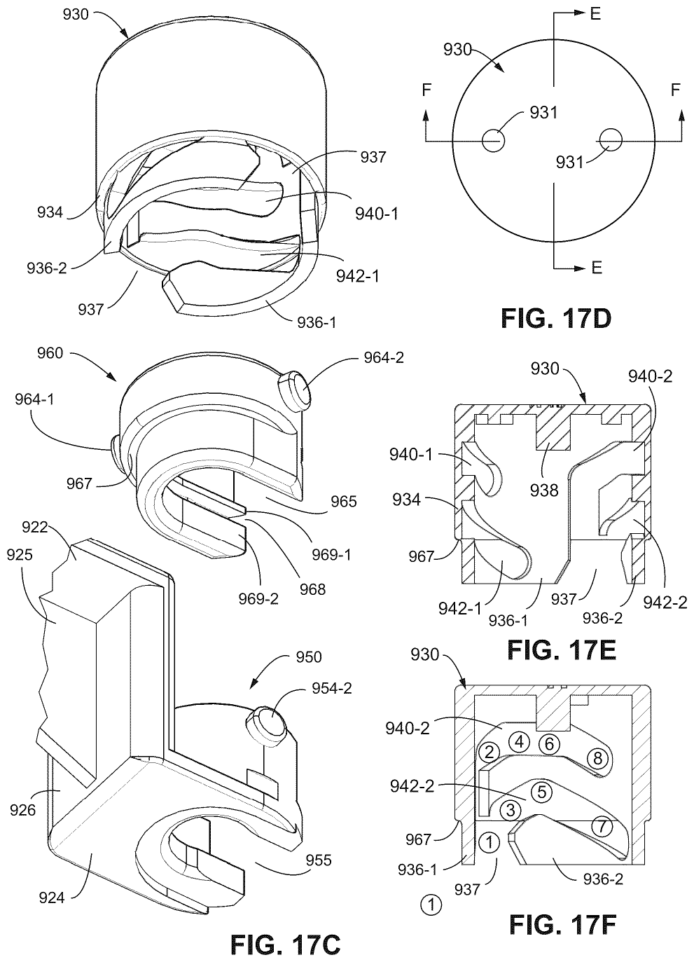

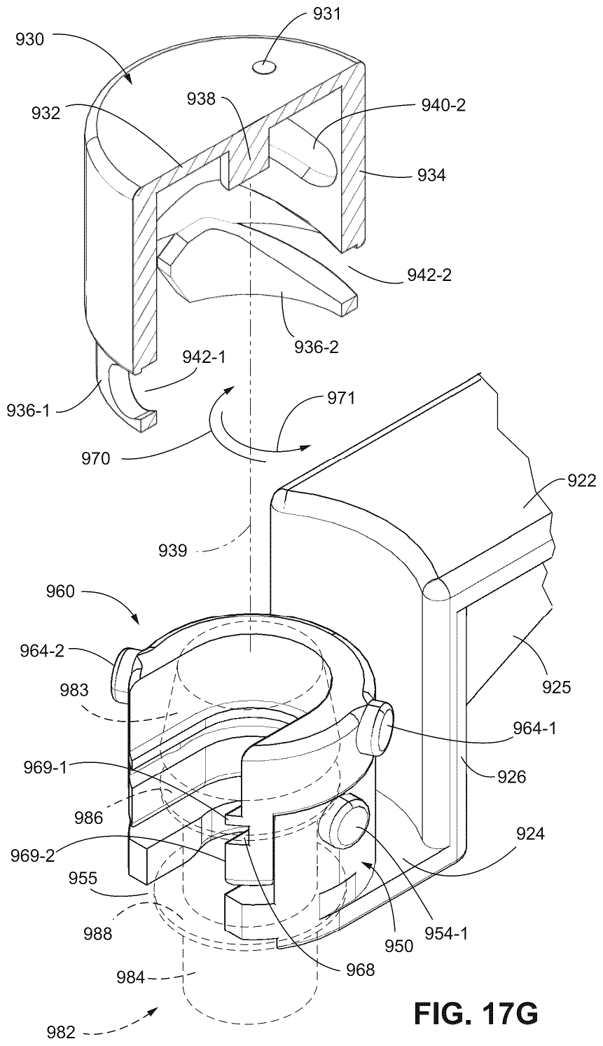

FIGS. 17A-17G show another add-on control apparatus 142, designated generally by reference number 900, for remote control of a manually operable control element 182 in the form of a power take off (PTO) control element 982 which requires a top button to be depressed and a flange to be lifted to engage the PTO. FIG. 17A is perspective view of the add-on PTO control apparatus 900 positioned above the PTO control element 982 provided on an armrest panel or console 182 of the work vehicle 100. The PTO control element 982 includes a top button 983 and a shaft 984. Disposed on the shaft 984 below the top button is an intermediate flange 986 and a bottom flange 988. The shaft 984 extends below the bottom flange 988 and projects through an apertured 985 in the armrest panel or console 182. The bottom flange 988 engages with the top surface of the armrest panel or console 182. A bottom washer 987 engages with the underside of the armrest panel or console 182. A nut 989 threadably engages with the lower threaded end of the shaft 984 thereby rigidly securing the PTO control element 982 to the armrest panel or console 182. The top button 983 is vertically movable with respect to the shaft 984 between a raised position and a depressed position. The intermediate flange 986 is also vertically movable with respect to the shaft 984 and with respect to the top button 983 when the top button is depressed. Thus to manually engage or to turn on the PTO of the vehicle, the operator is required to depress the top button 983 with his/her thumb and then lift upward on the intermediate flange 986 (usually held between the index and middle finger). To disengage or turn off the PTO, the operator simply depresses the top button 983 to release the spring bias, allowing the top button 983 to pop back up and thereby disengaging the PTO. The PTO control apparatus 900 is configured to perform these same tasks mechanically to engage and disengage the PTO.

Referring to FIG. 17A and the exploded views of FIGS. 17B and 17C, the add-on PTO control apparatus 900 includes a bracket 920. The bracket 920 includes and upper plate 922 and a lower base plate 924, joined by a vertical plate 926. A gusset 925 may be provided for rigidity of the main bracket 900. The PTO control apparatus 900 includes first and second control actuators 902a, 902b, such as electric linear actuators. Each of the linear actuators 902a, 902b (which correspond to the control actuators 202 as identified above and otherwise referenced throughout this description) includes a base end 903, a barrel 905 and a rod 907 that is extendable from the barrel 905. An electric motor 909 drives gears within the barrel to cause the rod 907 to extend from the barrel 905 and to retract within the barrel 905 as is well known in the art. Each of the linear actuators 902a, 902b includes a rearward ball joint 911 and a forward ball joint 913. The linear actuators 902a, 902b are omitted in FIGS. 17B, 17C and 17G. The rearward ball joint 911 of each of the actuators 902a, 902b may be mounted to the upper plate 922 by threaded connectors 915 which may extend through apertures 917 in the upper plate 922 and secured by nuts (not shown). The forward ball joints 913 are secured to a cap 930 (discussed below) by threaded connectors 915 extending through apertures 931 in the top wall 932 of the cap 930. Because the cap 930 is removed when placing the PTO control apparatus 900 onto the PTO control element 982 (as described below), it is convenient to secure the threaded fastener head to the underside of the cap 930 with the shaft of the threaded fastener projecting upward through the apertures 931 and utilizing wingnuts (not shown) to secure the forward ball joints 913 to the cap 930.

The cap 930 includes a top wall 932 and a cylindrical cap sidewall 934. Arcuate wall sections 936-1, 936-2 extend below the cylindrical cap wall 934, defining gaps 937 between the ends of the arcuate wall sections 936-1, 936-2. A central projection 938 extends downward inside the cap 930 from the bottom surface of the top wall 932 along the central axis 939 of the cap 930. The inner circumference of the cylindrical cap sidewall 934 and arcuate wall sections 936-1, 936-2 include partially spiral upper slots 940-1, 940-2 and partially spiral lower slots 942-1, 942-2.

A partial cylindrical base segment 950 extends upward from the lower base plate 924 of the bracket 922. The partial cylindrical base segment 950 has an outside diameter that is less than the internal diameter of the cylindrical cap wall 934 and arcuate wall sections 936-1, 936-2. The partial cylindrical base segment 950 has an internal diameter and forward opening 955 sized to receive the shaft 984 of the PTO control element 982. First and second base pins 954-1, 954-2 project outwardly from the partial cylindrical base segment 950 transverse to the forward opening 955.

An intermediate insert 960 is disposed between the cap 930 and the partial cylindrical base segment 950. The intermediate insert 960 includes an upper partially cylindrical segment 962 and a lower partially cylindrical segment 966 with a forward opening 965. The upper partially cylindrical segment 962 has an outside diameter that is substantially the same as the outside diameter of the partial cylindrical base segment 950. The upper partially cylindrical segment 962 has an inside diameter that is sized to receive the outside diameter of the top button 983 and the outside diameter of the intermediate flange 986 of the PTO control element 982 (see FIG. 17G). First and second intermediate pins 964-1, 964-2 project outwardly from the upper partially cylindrical segment 962 transverse to the forward opening 965. The lower partially cylindrical segment 966 has an outside diameter that is less than the inside diameter of the partially cylindrical base segment 250 such that the lower partially cylindrical segment is receivable within the partially cylindrical base segment 250. The difference between the outside diameter of the upper partially cylindrical segment 962 and the outside diameter of the lower partially cylindrical segment forms a seat 967 such that the upper partially cylindrical segment 962 sits upon the upper end of the partially cylindrical base segment 950. It should be appreciated that due to the smaller outside diameters of the lower partially cylindrical segment 966, straight segments extend toward the forward opening 965 resulting in the lower partially cylindrical segment 966 having a U-shape as best shown in FIGS. 17B and 17C. As a result of this U-Shape, the intermediate insert 960 is restrained from rotating within the partial cylindrical base segment 950. The lower cylindrical segment also includes a recess 968 defined by upper and lower flanges 969-1, 969-2. The upper and lower flanges 969-1, 969-2 project inwardly a sufficient distance to extend above and below the intermediate flange 986 of the PTO control element 982, but define an internal diameter less than the shaft 984 of the PTO control element 982 such that it may pass through the forward opening 965.

To place the PTO control apparatus 900 onto the PTO control element 982, the cap 930 is removed as shown in FIG. 17G exposing the open forward ends 955, 965 of the partial cylindrical segment 950 and the intermediate insert 960. The shaft 984 of PTO control element 982 is received through the open forward end 955 of the partial cylindrical base segment 950 and the open forward end 965 of the intermediate insert 960 as shown in FIG. 17G. The intermediate flange 986 is received within the recess 968 of the intermediate insert 960 and the top button 983 of the PTO control element 982 is received within the upper partially cylindrical segment 962 of the intermediate insert 960 through the open forward end 965. The cap 930 is repositioned over the intermediate insert 930 and the partial cylindrical base segment 950 and the intermediate pins 964-1, 964-2 are slidably received within the respective partially spiral upper slots 940-1, 940-2 of the cap 930 and the base pins 954-1, 954-2 are slidably received within the respective partially spiral lower slots 942-1, 942-2 of the cap 930. With the cap 930 in position, the central projection 938 on the inside of the cap 930 is disposed over the top button 983 of the PTO control element 982.

In this embodiment, the electric motors 909 of the first and second actuators 902a, 902b are functionally connected to the control circuit module 232 and are actuated under the command of the control circuit module 232 as previously described above in connection with the embodiments of the add-on control apparatus 142 of FIGS. 2, 4-8B, 9A-11, 14, 15 and 16.

In operation, the first and second linear actuators 902a, 902b are actuated simultaneously, with the first actuator 902a extending rod 907 and the second actuator retracting the rod 907. Because the rods 907 are attached to the cap 930 offset from the central axis 939 of the cap 930, the extension and retraction of the rods 907 will force the cap 930 to rotate about the central axis 939 relative to the stationary partial cylindrical base segment 950 in the clockwise direction as indicated by arrow 970 (FIGS. 17A, 17D). Referring to FIG. 17F, as the cap 930 rotates, the cap 930 is forced downwardly toward the base 922 (and the center projection 938 begins pushing down on the top button 983) due to the base pins 954-1, 954-2 sliding along the up-sloped length 1 of lower spirals 942. The intermediate pins 964 follow along the up-sloped length 2 of upper spirals 940. As the cap 930 continues to rotate downwardly as the lower pins 954-1, 954-2 continue to slide along the up-sloped length 3 of the lower spirals 942, the upper pins 964-1, 964-2 transition to the generally horizontal length 4 of the upper spirals 940, thus maintaining the intermediate insert 960 seated on the top end of the stationary partial cylindrical base segment 950. When the lower pins 954-1, 954-2 reach the apex of the lower spiral at point 5, the top button 983 is fully depressed by the center projection 938. As the cap 930 continues to rotate (via the continued extension and retraction of the rods 907 of the first and second actuators 902a, 902b, respectively), the upper pins 964-1, 964-2 move along the length 6 of the upper slots 940 and cause the intermediate insert 960 to raise relative to the stationary partial cylindrical base 950. Because the intermediate flange 986 of the PTO control element 982 is received within the recess 968 of the intermediate insert 960 (see FIG. 17G), the continued rotation of the cap 930 will cause the flange 986 to lift and lock the top button 983 of the PTO control element 982 in the ON position, thereby engaging the PTO of the work vehicle. Continued rotation of the cap 930 toward the down-sloped lengths 7, 8 of the lower and upper spirals 942, 940 releases the center projection 938 from engagement with the top button 983, but the PTO remains in the ON position because the flange 986 is in the up position maintaining the top button 938 in the ON position. To disengage or turn off the PTO, the first and second actuators 902a, 902b are again initiated to reverse their positions, whereby the rod 907 of the first actuator 902a begins to retract and the rod 907 of the second actuator 902b begins to extend causing the cap 930 to rotate in the direction of arrow 971. As the cap 930 rotates in the direction of arrow 971, the lower and upper pins 950, 960 begin moving back up the sloped areas 7, 8 of the slots 942, 940 causing the cap 930 to again move down toward the cylindrical base segment 950. This downward movement of the cap 930 pushes the center projection 938 against the top button 983 thereby releasing the downwardly biased flange 986 from its raised lock position and disengaging the PTO.

Based on the foregoing, it should be appreciated that the add-on control apparatuses 142 may be customized to fit different brands and/or models of the work vehicle 100. Moreover, the add-on control apparatuses 142 in some embodiments may be modularized such that different control actuator assemblies 202 may be detachably attached to the main frame assembly 220 and functionally connected to the control circuit module 232 to adapt to different brands and/or models of the work vehicle 100.

In above embodiments, the actuators are linear actuators similar to those shown in FIGS. 4A to 4D. Each actuator comprises a motor functionally connected to the control circuit module 232 for driving the actuator under the commands of the control circuit module 232. Those skilled in the art will appreciate that, in other embodiments, the actuators may be other suitable types such as rotary actuators and/or the like.

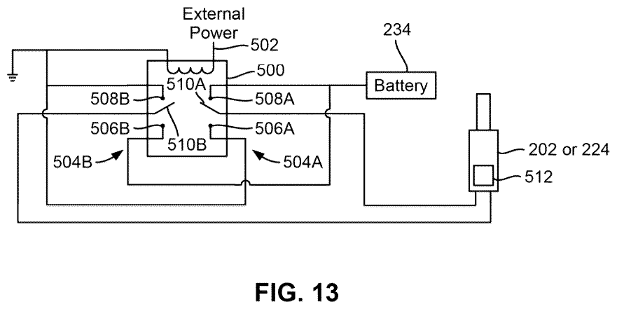

In some embodiments, each of the control actuators 202, 224 (which are also identified and cross-referenced by reference numbers 602, 712, 722, 802, 902 in the respective embodiments 600, 700, 800, 900 of FIGS. 14, 15A-15D, 16, 17A-17D, respectively) is coupled to a corresponding motor controlled by a corresponding relay for implementing the above-described emergency stop function. FIG. 13 shows an example.

As shown in FIG. 13, the relay 500 comprises a coil 502 and two switches 504A and 504B (collectively identified using reference numeral 504). Each switch 504 comprises a first terminal 506, a second terminal 508, and a throw 510 wherein the throw 510 is switchable between the first and second terminals 506 and 508, and is by default (that is, when the coil 502 is de-energized) connected to the first terminal 504.

The coil 502 is connected to the common ground at one end and connected to the external power via the control circuit module 232 (not shown). The battery 234 connects the common ground to the first terminal 506B of the second switch 504B and also to the second terminal 508A of the first switch 504A. The first terminal 508A of the first switch 504A and the second terminal 508B of the second switch 504B are connected to the common ground. The throws 510A and 510B of the first and second switches 504A and 504B are connected to the direct-current (DC) motor 512 of the control actuator 202 or 224.

In operation, the control circuit module 232 may connect or disconnect the coil 502 to the external power. When the coil 502 is connected to the external power, the coil 502 is energized and causes the throws 510A and 510B to connect the second terminals 508A and 508B, respectively, thereby powering the DC motor 512 of the control actuator 202 or 224 to actuate the corresponding control element (not shown). When the coil 502 is disconnected from the external power, the coil 502 is de-energized and causes the throws 510A and 510B to return to their default position, that is, connecting to the first terminals 508A and 508B, respectively, thereby reversing the current of the DC motor 512 of the control actuator 202 or 224 and causing the actuated control element to return to its default OFF position.

In the event of a loss of external power to the control circuit module 232 from the work vehicle 100, the coil 502 is de-energized and causes the throws 510A and 510B to return to their default position, that is, connecting to the first terminals 508A and 508B, respectively, thereby reversing the current of the DC motor 512 of the control actuator 202 or 224 and causing the actuated control element to return to its default OFF position.

In some embodiments, one or more of the control actuators 202 and 224 (which are also identified and cross-referenced by reference numbers 602, 712, 722, 802, 902 in the respective embodiments 600, 700, 800, 900 of FIGS. 14, 15A-15D, 16, 17A-17D, respectively) may comprise an actuator delimiter adjustable by the operator to adjust the actuation range. For example, a control actuator 202 comprises a delimiting extrusion movable with the actuation of the control actuator 202, and a range-limiting switch. The position of at least one of the delimiting extrusion and the range-limiting switch is adjustable by the operator. In operation when the actuator 202 is actuating, the delimiting extrusion is moved with the actuation. When the delimiting extrusion is in contact with and presses the range-limiting switch, the range-limiting switch then disconnects the motor of the actuator 202 and stops the actuation thereof.

With the various add-on control apparatuses 142 disclosed herein, one may readily convert a work vehicle 100 to a remote controllable vehicle without modifying the electrical and/or hydraulic circuits thereof. The modification to the work vehicle 100 may be minimal and may only involve mounting various components of the add-on control apparatuses 142 to suitable locations of the work vehicle 100 using suitable fastening means such as threaded fasteners, glue, straps, quick-release pins, and/or the like, and then engaging the control actuators 202 with respective manually operable control elements 182. In effect, the control actuators 202 mimic human fingers/hands to gain/allow movement of manually operable control elements 182.

In operation, the operator may stay outside the operator cab of the work vehicle 100 (for example, in proximity to the implements 108) and use the remote control 144 to start the engine 102 of the work vehicle 100, followed by actuating the control elements 182 as needed to operate corresponding functions of the work vehicle 100 and the implements 108 thereof. The statuses of the engine 102 and the control elements 182, such as wireless remote system on/off, engine on/off, engine RPM high/low, PTO on/off, hydraulic valve 1 on/off, and hydraulic valve 2 on/off, may be indicated by the indicator light 146 in suitable manners, such as using different colors or different pulse patterns, so that the statuses are visible to the operator external of the operator cab.

Although the ad-on control apparatuses 142 are ideally suited to convert a work vehicle 100 to a remote controllable vehicle, the add-on control apparatuses 142 may be adapted to automatically operate the manually controllable elements 182 of work vehicles 100 that are semi-autonomous or supervised-autonomous work vehicles 100.

### Semi-Autonomous Work Vehicles

In the agricultural industry, for example, it is now common for tractors, combine harvesters, sprayers and other agricultural vehicles (collectively hereinafter “farm vehicles”) to essentially drive themselves through a field while performing tillage, planting, spraying and harvesting operations. These so-called hands-free, self-driving or automated steering farm vehicles 100 still require an operator sitting in the vehicle's seat to physically steer the farm vehicle 100 at certain times, to avoid obstacles in the field or other areas or conditions not conducive to hands-free operation. Otherwise, the actual steering of the farm vehicle 100 from one end of the field to the other is controlled by an automated guidance system (“AGS”) which relies on precise global positioning system (GPS) technology, such as real-time kinetic (RTK) positioning. The AGS may be one of the vehicle's many electronic control units (ECUs) or the AGS may be a third party or aftermarket ECU. The AGS and the other ECUs on the vehicle (whether original equipment or third party) utilize a controlled area network (CAN) for data communication that is typically based on the ISO 11783 protocol developed for agricultural equipment. The AGS in combination with other ECUs receive signals from multiple sensors on the vehicle 100 and/or implement 108 (e.g., engine speed sensors, ground speed sensors, GPS, etc.) to autosteer the vehicle along a preset course through the field at a preset ground speed that is set by the operator via a user interface on one or more in-cab monitors or mobile devices (collectively “monitors”) also in communication with the CAN. The monitors typically include a graphical user interface (GUI) and a display screen, through which the operator inputs and views the vehicle setup information, field boundaries, and other operating parameters and performance of the vehicle 100 and implement 108.

In these semi-autonomous vehicles 100, the operator will set the initial desired path (i.e., the “AB line”) of the vehicle through the field via the monitor, along with the desired engine speed, desired ground speed, and other necessary inputs, such as field boundaries, the width of the implement, offsets from the GPS receiver relative to the implement, etc. Once the AB line and other user inputs are entered via the monitor, the operator will physically steer the farm vehicle 100 and implement 108 into alignment with the AB line. With the farm vehicle 100 and implement 108 aligned with the AB line, the operator physically manipulates the control elements 182 (buttons, levers, switches, etc.) on the control panel 110 to place the implement into the working condition, which may include lowering the implement to the proper elevation relative to the ground, engaging the power-take-off (PTO), and engaging hydraulic, electric or pneumatic motors, fans, pumps, etc., depending on the vehicle 100 and implement 108 being used. The operator will then begin to physically drive the farm vehicle 100 and implement 108 along the AB line at or near the desired engine speed and ground speed before activating the AGS. Once activated, the AGS takes control over steering the vehicle and adjusts the engine speed and gears as necessary to maintain the preset ground speed. As the farm vehicle 100 and implement 108 approaches the headlands at the other end of the field, the operator will disengage the AGS and physically manipulate the various the control elements 182 (buttons, levers, switches, etc.) on the control panel 110 to take the implement out of the working position (e.g., raising the implement above the soil), reduce engine speed, downshift, etc. before the turning the vehicle and implement for realignment with the next AB line for the next pass through the field. Once aligned, the operator again physically manipulates the control elements 182 to again place the implement into the working condition, and begins to drive along the next AB line until before engaging the AGS to again take control over steering of the vehicle, the engine speed and ground speed until the other end of the field is reached or until operator control is needed. This process is repeated, until the field work is completed. Thus, it should be appreciated that the more mundane task of steering the farm vehicle is automatically controlled by the AGS, allowing the operator to focus on the other operational functions or the performance of the vehicle 100 and/or the implement 108.

### Supervised Autonomous Work Vehicles

Supervised autonomous vehicles 100 are those that are directly supervised in the filed by the operator, but the operator need not be present inside the vehicle. Supervised autonomous vehicles may include “master and slave” vehicle arrangement or a single vehicle that is supervised by a remote operator.

In a master and slave supervised autonomous arrangement, there is a lead “master” vehicle with a supervising operator and a driverless “slave” vehicle that is in wireless communication with the lead operated vehicle. The master vehicle is typically equipped with the AGS and GPS/RTK positioning technology and the various ECUs and sensors described above in connection with the semi-autonomous vehicles. The operator in the operated master lead vehicle determines the speed and direction of the vehicle, performs that physical tasks of moving the lead operated vehicle and implement into and out of working positions, activating and de-activating the lead vehicle's AGS, and physically turning the lead operated vehicle at the headlands or other areas of the field. These commands are transmitted wirelessly to the driverless slave vehicle which imitates the commands and actions performed by the supervising operator in the master lead vehicle.

In the single-vehicle supervised autonomous arrangement, the vehicle is essentially a semi-autonomous vehicle as described above, but with the supervising operator outside or remote from the vehicle. In the single-vehicle supervised autonomous arrangement, the ECUs of the vehicle may be programmed to automatically perform most of the operations that would otherwise be physically performed by the operator sitting in the seat of the semi-autonomous vehicle, or the supervising operator may perform the operations remotely that would otherwise be physically performed by the operator sitting in the seat of the semi-autonomous vehicle.

It should be appreciated that with semi-autonomous farm vehicles 100, or the master-slave supervised autonomous vehicles 100, the ad-on control apparatuses 142 could be utilized to automate some or many of the tasks ordinarily performed by the operator sitting in the cab of the semi-autonomous farm vehicles 100, or sitting in the cab of the master vehicle of the master/slave supervised autonomous vehicle, or remotely by the operator in the single-vehicle supervised autonomous vehicle. Additionally, the ad-on control apparatus 142 could be utilized in the slave vehicle of the supervised autonomous vehicle arrangement. Likewise, fully autonomous farm vehicles may be equipped with the ad-on control apparatuses 142 to perform certain operations controlled by the ECUs. In each of the semi-autonomous, supervised autonomous or fully autonomous farm vehicles, the control circuit module 232 may interface with the vehicle's CAN system. The control circuit module 232 may include circuitry and programming to convert the CAN messages generated by the ECUs to analog signals to actuate the control actuators 202 of the ad-on control apparatuses 142 to manipulate the control elements 182 that would otherwise be manipulated by the operator (in the cab or remotely).

By way of example, with semi-autonomous farm vehicles 100, when the GPS on the farm vehicle 100 detects that the vehicle is approaching a headland of the field, the ECUs associated with the GPS and AGS may generate CAN messages which are received by the control circuit module 232. The control circuit module 232 may be programmed to actuate certain control actuators 202 on the ad-on control apparatus 142 to, for example, cause the vehicle 100 to throttle down to reduce the ground speed, to downshift as needed, to raise the implement from the working position, and to turn the vehicle 100 to align with the next AB line to start a new pass through the field. Once the GPS and AGS confirm that the vehicle 100 is in alignment with the AB line for the next pass through the field, the ECUs associated with the GPS and AGS may generate another CAN message received by the control circuit module 232 to actuate certain of the control actuators 202 on the ad-on control apparatus 142 to lower the implement to the working position, throttle up and/or shift gears to match the preset desired ground speed.

It should be appreciated that when using the add-on control apparatuses 142 with semi-autonomous and supervised autonomous vehicles, the systems can be used without the remote control 144 since the control actuators 202 of the add-on control apparatuses 142 may be actuated via the interface with the vehicle's ECUs and CAN.

Based on the foregoing, it should be appreciated that a method of controlling manually operable control elements 182 of a vehicle 100, includes mounting a control apparatus 142 in the vehicle 100 in proximity to the manually operable control elements 182 of the vehicle 100 such that at least one control actuator 202 of the control apparatus 142 is in mechanical engagement with at least one of the manually operable control elements 182 of the vehicle 100. The control circuit module 232 of the control apparatus 142 receives command signals from a control source. The control source may be a remote control 144 operated by an operator. Alternatively, the control source may be one or more ECUs on the vehicle 100 with which the control circuit module 232 is in signal communication via a CAN. The control circuit module 232 generates a signal based on the received commands from the control source to cause actuation of the control actuator 202. The actuation of the control actuator 2020 mechanically manipulates the manually operable control element 182 of the vehicle 100 with which the control actuator 202 is mechanically engaged. The vehicle 100 may be any of the vehicles described above, including but not limited to, a semi-autonomous vehicle and supervised autonomous vehicles.

Although work vehicles and farm vehicles are described in the above embodiments, those skilled in the art will appreciate that the vehicle 100 in other embodiments may be any suitable vehicle.

Although embodiments have been described above with reference to the accompanying drawings, those of skill in the art will appreciate that variations and modifications may be made without departing from the scope thereof as defined by the appended claims.

1. A system for remotely controlling manually operable control elements of a vehicle, the system comprising:
a control apparatus mounted within the vehicle and mechanically engaged with at least one manually operable control element of the vehicle;
a control circuit module configured to receive commands from a control source and configured to output command signals;
at least one control actuator in signal communication with the control circuit module, the at least one control actuator responsive to the command signals output by the control circuit module;
wherein the at least one manually operable control element includes:
a joystick control element movable in fore and aft directions and in right and left lateral directions; or
a PTO control element capable of engaging a PTO of the vehicle, the PTO control element having a shaft, a top button and a flange, whereby to engage the PTO of the vehicle, the top button is pushed downward and the flange is lifted upward;
wherein the control apparatus includes:
a joystick control apparatus engaged with the joystick control element, wherein the joystick control apparatus is configured to be manipulated by the at least one control actuator to move the joystick control element in both the fore and aft directions and the right and left lateral directions in response to the command signals output by the control circuit module based on commands received from the control source; or
a PTO control apparatus engaged with the PTO control element, wherein the PTO control apparatus is capable of pushing down on the top button and lifting the flange of the PTO control element to engage the PTO in response to the command signals output by the control circuit module based on commands received from the control source.

2. The system of claim 1, wherein the control source is a remote control device.

3. The system of claim 1, wherein the control source is a controlled area network in signal communication with the control circuit module.

4. The system of claim 1, wherein the at least one actuator of the joystick control apparatus includes a fore/aft actuator configured to move the joystick control element in the fore and aft directions and a right/left actuator configured to move the joystick control element in the right and left lateral directions.

5. The system of claim 4, wherein the joystick control apparatus further comprises:
a main frame configured to mount to an armrest or console of the vehicle;
a fore/aft subframe supported by and moveable relative to the main frame in the fore and aft directions;
a right/left subframe supported by and moveable relative to the fore/aft subframe, the right/left subframe receiving and mechanically engaging with the joystick control element;
wherein the fore/aft actuator includes:
fore/aft gear teeth;
a fore/aft gear in engagement with the fore/aft gear teeth;
a fore/aft electric motor configured to drive the fore/aft gear along the fore/aft gear teeth;
wherein the right/left actuator includes:
right/left gear teeth;
a right/left gear in engagement with the right/left gear teeth;
a right/left electric motor configured to drive the right/left gear along the right/left gear teeth.

6. The system of claim 5, further comprising:
fore/aft guide rails extending in the fore and aft directions;
right/left guide rails extending in the right and left lateral directions, transverse to the fore and aft directions;
fore/aft rail receivers extending in the fore and aft directions, the fore/aft rail receivers mateably and slidably receiving the fore/aft guide rails;
right/left rail receivers extending in the right and left lateral directions, transverse to the fore and aft directions, the right/left rail receivers mateably and slidably receiving the right/left guide rails.

7. The system of claim 6, wherein:
the fore/aft gear teeth are disposed on a sidewall of the main frame;
the fore/aft gear is supported on the fore/aft subframe;
the fore/aft electric motor is supported on the fore/aft subframe;
the right/left gear teeth are disposed on the right/left subframe;
the right/left gear is supported on the fore/aft subframe;
the right/left electric motor is supported on the fore/aft subframe;
the fore/aft guide rails are disposed on the main frame;
the fore/aft rail receivers are disposed in the fore/aft subframe;
the right/left guide rails are disposed on the fore/aft subframe; and
the right/left rail receivers are disposed in the right/left subframe.

8. The system of claim 1, wherein the PTO control apparatus comprises:
a bracket configured to mount to an armrest or console of the vehicle, the bracket including a partially cylindrical base segment with an opening sized to receive the shaft of the PTO control element, the partially cylindrical base segment including outwardly projecting base pins;
an intermediate insert sized to seat within the partially cylindrical base segment, the intermediate insert having an opening sized to receive the shaft of the PTO control element, the intermediate insert including inwardly projecting upper and lower flanges spaced to receive the flange of the PTO control element therebetween, the intermediate insert including outwardly projecting upper pins;
a cap sized to fit over the top button, the cap having a cap wall defining partially spiral slots to receive the upper pins and the base pins, an inside of the cap including a downward projection; and
wherein the at least one control actuator includes a first actuator and a second actuator each attached to the cap at one end and each attached to the bracket at another end;
whereby actuating the first and second actuators causes rotation of the cap in a first direction forcing the cap to move downwardly due to the base pins and upper pins moving along up-sloped portions of the partially spiral slots, such that the downward projection on the inside of the cap engages with and pushes the top button downward, and as the cap continues to rotate in the first direction, the upper pins move along a generally horizontal portion of the partially spiral slots while the base pins move along a down-sloped portion of the spiral slots, such that the intermediate insert is lifted upwardly relative to the partially cylindrical base segment causing the lower flange of the intermediate insert to force the flange of the PTO control element upward, thereby actuating the PTO control element to engage the PTO of the vehicle.

9. The system of claim 1, wherein the at least one manually operable control element further includes:
a brake pedal control element movable between a raised position and a depressed position; and
wherein the control apparatus is a brake pedal control apparatus capable of moving the brake pedal control element from a raised position to a depressed position in response to the command signals output by the control circuit module based on commands received from the control source.

10. The system of claim 9, wherein the at least one actuator is a linear actuator, the linear actuator including a base mounted to the console of the vehicle, an extendable rod in engagement with the brake pedal control element, and an electric drive motor configured to extend and retract the rod.

11. A method of controlling a joystick control element of a vehicle with the system of claim 5, the method comprising:
actuating the fore/aft electric motor via the control source to drive rotation of the fore/aft gear along the fore/aft gear teeth such that the fore/aft subframe moves in the fore and aft directions relative to the main frame, thereby causing the joystick control element to move in the fore and aft directions, respectively;
actuating the right/left electric motor via the control source to drive rotation of the right/left gear along the right/left gear teeth such that the right/left subframe moves in the right and left lateral directions relative to fore/aft subframe and the main frame, thereby causing the joystick control element to move in the right and left lateral directions, respectively.

12. A method of controlling a PTO control element of a vehicle with the system of claim 8, the method comprising:
positioning the shaft of the PTO control element within the opening of the partially cylindrical base segment and within the opening of the intermediate insert;
positioning the flange of the PTO control element between the upper and lower flanges of the intermediate insert;
positioning the cap over the top button and aligning the upper pins of the intermediate insert and the lower pins of the partially cylindrical base segment within the partially spiral slots of the cap wall;
actuating the first and second actuators via the control source to cause rotation of the cap in the first direction forcing the cap to move downwardly and forcing the flange of the PTO control element upward, thereby actuating the PTO control element to engage the PTO of the vehicle.

13. A method of controlling a brake pedal control element of a vehicle with the system of claim 10, the method comprising:
actuating the electric drive motor via the control source to extend the rod such that the brake pedal control element is forced downward, thereby engaging the brakes of the vehicle.
